(19) United States
(12) Patent Application Publication
(10) Pub. No.: US 2021/0225531 A1
(43) Pub. Date: Jul. 22, 2021

(54) METHOD AND APPARATUS FOR INITIATING AND MAINTAINING NUCLEAR REACTIONS

(71) Applicants: David BROWN, Helsinki (FI); Andras KOVACS, Espoo (FI); Fredrik EK, Siuntio (FI)

(72) Inventors: David BROWN, Helsinki (FI); Andras KOVACS, Espoo (FI); Fredrik EK, Siuntio (FI)

(21) Appl. No.: 15/734,711

(22) PCT Filed: Mar. 8, 2019
(86) PCT No.: PCT/FI2019/050189

§ 371 Date: Dec. 3, 2020

(30) Foreign Application Priority Data
Jun. 4, 2018 (FI) 20187078

(51) Int. Cl. G21B 3/00; G21C 1/30

(52) U.S. Cl. CPC G21B 3/00; G21C 1/30

(57) ABSTRACT

This disclosure relates to a method and apparatus for energy production from at least one of electron-mediated nuclear reaction and single-element nuclear reaction, wherein a reactive nuclei fuel is loaded into a reactor. The fuel includes one or more reactive nuclei. To maintain a chain reaction, the fuel structure has a multiplication factor of energetic electrons larger than one. A chain reaction is initiated and/or periodically re-initiated in the fuel.

### CROSS REFERENCE TO RELATED APPLICATIONS

This application is a national phase application of International Application no.: PCT/FI2019/050189, filed on Mar. 8, 2019, and claims priority to Finnish application 20187078, filed on Jun. 4, 2018, the content of both of which is herein incorporated by reference.

### FIELD OF THE INVENTION

The present invention relates to energy production. More specifically, the invention discloses a method and apparatus for energy production from nuclear reactions. The nuclear reactions may be electron-mediated and/or from a single element fuel.

### BACKGROUND OF THE INVENTION

New energy technologies for the future replacement of fossil-fuel based energy sources are being urgently promoted by governments and society and are under intense research. Ongoing “beyond-fossil” energy research may be broadly split into technologies a) relying on direct or indirect harnessing of the incoming power from the Sun, and b) nuclear technologies. The present invention is believed to fall in the nuclear technology category. While the present invention provides similar energy and power density as nuclear fission based technologies, it can be differentiated by allowing for essentially radioactivity-free reactor design.

Other preceding radioactivity-free nuclear inventions mainly relate to energy generation based on Nickel-Hydrogen and Palladium-Deuterium fuel couples. The industrialization of these preceding inventions is not straightforward, preventing the commercial exploitation of such preceding inventions to date. Up to now, only neutron-mediated chain reaction of heavy nuclei has been industrially developed. It is the basis of all current nuclear energy production.

An energy generating reaction arising within a fuel has great potential utility. The presently disclosed invention facilitates its industrial utilization by the virtues of its reliable start-up, good controllability, and sufficiently high power density. The production of energy from certain fuels and the technology for optimal electricity conversion from such energy producing processes are complementing aspects of the disclosed invention.

### SUMMARY OF THE INVENTION

A method and apparatus for Electron-Mediated Nuclear Reaction (EMNR) in reactive nuclei fueled reactors is disclosed. The EMNR may be net exothermic. Distinct reaction dynamics of a pulsed and a continuous reaction process are disclosed. These distinct dynamics may correspond to different nuclear reaction processes. The continuous reaction dynamics may be highly controllable. This controllable characteristic, its high (e.g. 30 W/g) reaction power rate, and the reliable reaction start-up offers great potential for future energy production. The method and apparatus may incorporate materials which enable the presence of metastable electron orbitals, highly localized electron orbitals and/or close electron-nucleus proximity orbitals (“Electron Mediated Nuclear Reaction Promoting Orbitals” or EMNRPOs) around a nucleus in the fuel. Said orbitals may have “Electron Mediated Nuclear Reaction Promoting Orbital Electrons” (EMNRPOEs) having “Electron Mediated Nuclear Reaction Promoting Orbital Electron Total Energies” (EMNRPOETEs). Said orbitals may be zitterbewegung orbits. Said zitterbewegung orbits may have “Zitterbewegung Orbital Electrons” (ZOEs) having “Zitterbewegung Orbital Electron Total Energies” (ZOETEs). The fuel of the method and apparatus may include Electron Mediated Nuclear Reaction Promoting Orbital Capable Material (EMNRPOCM), such as Zitterbewegung Orbit Capable Material (ZOCM), such as ¹H nuclei or ²H nuclei, which may catalyze or otherwise promote EMNRs. Transition of electrons to EMNRPOs may be facilitated or otherwise promoted by the presence of Transition-Initiating Kinetic Energy Electron Orbitals (TIKEEOs) having electrons with Transition-Initiating Kinetic Energies (TIKEs) close to one or more EMNRPOTE of one or more EMNRPOCMs in the fuel. In the case that a EMNRPOCM is a ZOCM, said EMNRPOETE is a ZOETE and one or more TIKEs may be close to ˜80-81 eV when the ZOCM is hydrogen (¹H), with a ZOETE of ˜80-81 eV and may be close to ˜35 eV when the ZOCM is deuterium (²H or D), with a ZOETE of ˜35 eV. A method to predict reactive nuclei and fuels according to the invention is disclosed.

One aim of the present invention is to disclose a fuel for nuclear reaction. A single or multi-element fuel for nuclear reaction is disclosed. The fuel may comprise one or more reactive nuclei (a reactive nuclei fuel). The fuel may comprise one or more Nuclear Double Electron Capture Capable Isotopes (NDECCIs). The fuel may comprise one or more EMNRPOCMs, such as ZOCMs. The fuel may further comprise one or more “Transition-Initiating Kinetic Energy Electron Orbital Materials” (TIKEEOMs) and/or their precursors. One or more of the EMNRPOCMs may be light nuclei materials. The light nuclei EMNRPOCMs may be hydrogen (¹H) and/or deuterium (²H). The fuel may comprise a “Transition-Initiating Kinetic Energy Electron Orbital Modulatable Material” (TIKEEOMM). One or more of the TIKEEOMs may be a metal. One or more of the metals may be an alkali metal, an alkaline earth metal, a transition metal, a post-transition metal, a lanthanide and/or an actinide. One or more of the TIKEEOMs may be a component of an “Orbital Modified Compound Material” (OMCM). The OMCM may be, for instance, a molecule, an alloy or a salt comprising, at least in part, one or more TIKEEOMs. The OMCM may be a “Transition-Initiating Kinetic Energy Electron Orbital Compound Material” TIKEEOCM. The TIKEOCM may be a TIKEEOM. The molecule may be, for instance, a borate, a boride, an oxide, a nitride, a nitrate, an oxide, a fluoride, a silicate, a phosphate, a sulfate, a chloride, a selenide, a bromide, an iodide, a nitrate, a nitride, a phosphate, a phosphine, a phosphide, a sulfate, a sulfide or any other molecular combination. The fuel structure may have a multiplication factor of energetic electrons larger than one. The fuel may be used in a method or apparatus for EMNR, for instance an Electron-Mediated Nuclear Chain Reaction (EMNCR).

According to one embodiment of the invention, an exothermic nuclear reaction, such as an EMNR, may be enabled by a strong magnetic field. According to one embodiment of the invention, the exothermic nuclear reaction may comprise an exothermic rearrangement of one or more nuclear bonds within a fuel, the exothermic breakup of one or more nuclear bonds within a fuel and/or the exothermic breakup of one or more nucleons within a fuel. The magnetic field may be created by an electron in an EMNRPO, for instance a zitterbewegung orbit, by a magnetic monopole, and/or by a sufficiently strong current pulse.

According to one embodiment of the invention, a method and apparatus for EMNR is disclosed in which one or more EMNRPOCMs and one or more “Transition-Initiating Kinetic Energy Electrons” (TIKEEs) having kinetic energy close to a EMNRPOETE of one or more EMNRPOCMs are transitioned to form one or more EMNRPOs around the nucleus of one or more EMNRPOCMs. One or more TIKEs may be bound electrons or unbound electrons. In the case of bound electrons, said electrons may be bound in an orbital of a TIKEEOM. The TIKE may be close to ˜80-81 eV in the case of an EMNRPOCM comprising ¹H and the TIKE may be close to ˜35 eV in the case of an EMNRPOCM comprising ²H. The EMNRPOCM may be a ZOCM. The EMNRPO may be a zitterbewegung orbit. The EMNRPO may catalyze, enhance or otherwise promote one or more nuclear reactions. Examples of ¹H compatible TIKEEOMs include, but are not limited to materials comprising Ni, Br, V and/or Co. Examples of ²H compatible TIKEEOMs include, but are not limited to materials comprising Ca. TIKEEs may be supplied to the EMNRPOCMs by any means. TIKEEs may be provide by bound electrons and/or unbound electrons. Examples of means of supplying TIKEEs from bound electrons include, but are not limited to, diffusing one or more EMNRPOCMs through a material comprising TIKEEOMs, accelerating one or more EMNRPOCMs into a material comprising TIKEEOMs (for instance by surface plasmons, surface voltage during electrolysis, or acceleration by Fermi-level difference across a surface interface (e.g. during non-equilibrium diffusion), for instance, by melting phase changes, e.g., melting alloys containing one or more TIKEEOMs into an other material of lower Fermi level, and/or accelerating TIKEEOMs into a material comprising EMNRPOCMs. Examples of means of supplying TIKEEs from unbound electrons include, but are not limited to, providing a plasma comprising one or more EMNRPOCMs, wherein the plasma temperature is close to the EMNRPOETE and/or bombarding a material comprising EMNRPOCMs with electrons with energies close to the EMNRPOETE. Electrons may be transitioned to ENMRPO by bombarding a material comprising EMNRPOCMs with ions, preferably EMNRPOCM ions, with energies higher than the EMNRPOETE, preferably energies close to three times (3×) the EMNRPOETE.

One aim of the present invention is to disclose the method and apparatus for energy production from a fuel. A method and apparatus for producing energy from electron-mediated nuclear reactions is disclosed, including electron mediated nuclear chain reactions. As a preferred embodiment, Lithium and/or Nickel containing fuels are disclosed. As a more preferred embodiment, ⁵⁸Ni containing fuels and ⁶Li-⁷Li fuel mixtures are disclosed. Other fuels or fuel components are possible according to the invention. An electron-mediated and/or single element fueled nuclear reaction is disclosed. An electron-mediated and/or single element fueled nuclear reaction with ⁵⁸Ni is disclosed. An electron-mediated and/or single element fueled nuclear reaction with ⁶Li-⁷Li mixtures is disclosed. A single element fueled nuclear reaction may be an electron mediated nuclear chain reaction. A electron-mediated reaction may be a single element reaction. A single element fueled nuclear reaction may be an electron-mediated nuclear reaction. An electron-mediated and/or single element fueled nuclear reaction may be, in its initial phase an electron mediated nuclear chain reaction. An electron mediated nuclear reaction may be a continuous or semi-continuous nuclear reaction. An electron-mediated and/or single element fueled nuclear chain reaction may be, in its initial phase an electron mediated or single-element nuclear reaction. An electron mediated or single-element nuclear reaction may be a continuous or semi-continuous nuclear reaction. An electron mediated nuclear chain reaction or chain reaction may transition from an initial and/or periodic nuclear chain reaction or nuclear reaction into a continuous or semi-continuous nuclear reaction or nuclear chain reaction. The electron-mediated and/or single element fueled nuclear reaction or chain reaction may be net exothermic reaction. A mechanism that enables an electron mediated or single element fueled reaction sequence is disclosed.

Multiple reactions are disclosed, including, but not limited to: nickel fueled and lithium fueled reactions. The reactions may be chain reactions. ⁵⁸Ni containing fuels and ⁶Li-⁷Li fuel mixtures are disclosed as exemplary fuels for electron mediated nuclear chain reactions and/or single element fueled nuclear chain reactions, though other fuels are possible according to the invention. One or more nuclear reaction chains may be initiated by the nuclear capture of energetic electrons or by other means as will be described herein, and the reaction may generate a higher number of energetic electrons as that input, i.e., nuclear capture of energetic electrons may lead to multiplication of energetic electrons. A fuel may be placed in a reactor. A fuel may be used to generate an excess of energetic electrons from one or more NDECCIs or from lithium. The fuel may comprise, at least, an NDECCI and/or a lithium isotope and may further contain other components which may include, for instance, one or more modifying materials. A fuel may be a single element or a multi element fuel. The fuel may comprise a modifying material. A fuel may contain only a single element. The single element fuel may contain multiple isotopes of said single element. Such a fuel comprised of only multiple isotopes of a single element is considered a single element fuel, according to the invention. A nuclear reaction utilizing a single element fuel is terms a “single element fueled reaction”.

According to one embodiment of the invention, the chain reaction sequence may involve one or more electron-capture steps and one or more energetic electron emission steps. The energetic electron emissions may be multiplied compared to the electron captures. The number of emitted electrons due to an electron capture or group of electron captures may be greater than one. According to one aspect of the invention, the reactions may be self-regulating. According to one aspect of the invention, sustainable energy production may be achieved. Metallic nickel and/or lithium may be used as fuel, according to the invention. Moreover, any NDECCI containing material may be used as a fuel, alone or in combination, according to one embodiment of the invention.

An EMNR may be initiated or preceded by an electron transition event. Examples of electron transition events include, but are not limited to, transition of electrons to EMNRPOs, such as zitterbewegung orbits. Bound electrons or unbound electrons may transition to EMNRPOs. An EMNR may be a step a single or multi-step process. EMNRPOs, such as zitterbewegung orbits, may catalyze, enhance or otherwise promote one or more EMNRs and/or one or more EMNCRs.

“Bound electrons” are electrons bound in an orbital of a nucleus. A TIKEE of a TIKEEO of a TIKKEOM is an example of a bound electron.

“Electron capture” means any process in which a proton-containing nucleus of an atom absorbs an electron, thus, changing one or more nuclear protons to one or more nuclear neutrons. An EMNR may comprise one or more electron capture events. Electron capture may be, for instance, single electron capture and/or double electron capture. Double electron capture may occur as a sequence of single electron capture events or as a single event. A double electron capture is an example of an EMNR. Other EMNR are possible according to the invention.

Not to be bound by theory, it is believed that an energy producing reaction may be triggered by solid-molten phase changes of the fuel. The phase changes may be full or partial. The full or partial phase changes may be kept ongoing by temperature cycling, for instance, temperature cycling around the phase-change temperature region. The temperature cycling or other triggering mechanism may be continuous or intermittent.

In addition to describing a preferred embodiment, the invention discloses a family of materials, which may produce energy according to the reaction mechanism or operating principle disclosed herein.

Moreover, an apparatus for energy production comprising a reactor for containing a fuel is disclosed. The apparatus may further employ means for maintaining an essentially chemically inert environment around the fuel. The apparatus may further employ means for cycling the temperature of the alloy within a target temperature range.

“Electron-mediated nuclear reaction” is here defined as a nuclear reaction process, characterized by the presence of one or more electrons in close electron-nucleus proximity. The electron-mediated nuclear reaction may be sustained, intermittently or continuously, by the production of electrons in close electron-nucleus proximity by, as part of, during or in the reaction.

“Electron-mediated nuclear chain reaction” is here defined as a nuclear reaction process, characterized by the emission and nuclear capture of energetic electrons. The electron-mediated nuclear chain reaction may be sustained, intermittently or continuously, by the multiplication of energetic electrons by, as part of, during or in the reaction.

An Electron-Mediated Nuclear Chain Reaction (EMNCR) may comprise two or more Electron-Mediated Nuclear Reaction (EMNRs) in series. An EMNR may be a EMNCR. An EMNCR is a type of EMNR.

A “high energy” or an “energetic” electron is here understood to mean, for instance, an electron having a kinetic energy above the endothermic barrier for single electron capture in the reactive nuclei of the fuel material. An EMNR may comprise a single electron capture step. Single electron capture may be one step in an EMNR.

A “Transition-Initiating Kinetic Energy Electron Orbital Material” (TIKEEOM) is a material that has at least one s, p, d, or f electron orbital, or one or more hybrids thereof, having a kinetic energy close to an EMNRPOETE, for instance, a ZOETE, of one or more EMNRPOCMs, such as ZOCMs, employed in a fuel. A TIKEEOM can be produced from, for instance, a TIKEEOMM, including a TIKEOMCM.

A “Transition-Initiating Kinetic Energy Electron Orbital Modulatable Material” (TIKEEOMM) is a material that has, or can be modulated or otherwise modified, for instance by an OMM, to have, at least one s, p, d, or f electron orbital, and/or one or more hybrids thereof, having a kinetic energy close to the EMNRPOETE of an EMNRPOCM, such as a ZOETE of one or more ZOCMs employed in a fuel. Thus, if it is not already a TIKEEOM, at TIKEEOMM may be changed to a TIKEEOM by, for instance, combining with an OMM. A TIKEEOMM may also be a TIKEEOM, a TIKEEOMCM and/or a TIKEEOCM. A TIKEEOMM may also be an NDECCI and/or a modifying material. A TIKEEOM may be modified by, for instance, an OMM, to be a more effective or efficient TIKEEOM. Thus, a TIKEEOM may be a TIKEEOMM.

A “Transition-Initiating Kinetic Energy Electron Orbital Compound Material” (TIKEEOCM) is a material or combination of materials that has been modified, for instance, by an OMM, to have, at least one s, p, d, or f electron orbital, or one or more hybrids thereof, having a kinetic energy close to an EMNRPOETE, for instance a ZOETE, of one or more EMNRPOMs, for instance the ZOCMs, employed in a fuel. A TIKEEOCM can be produced, for instance, from a TIKEEOM, a TIKEEOMM or a TIKEEOMCM and an OMM. A TIKEEOCM is a type of TIKEEOM. A TIKEEOM may be a TIKEEOCM.

A “Transition-Initiating Kinetic Energy Electron” (TIKEE) is an electron having a TIKE. The electron may be an unbound electron or may be a bound electron in the orbital of a TIKEEOM, including a TIKEEOCM, having a kinetic energy close to an EMNRPOETE, such as a ZOETE, of one or more EMNRPOCMs, such as ZOCMs, employed in the fuel.

A “Transition-Initiating Kinetic Energy” (TIKE) is an electron kinetic energy close to an EMNRPOETE, such as a ZOETE, of one or more EMNRPOCMs, such as ZOCMs, employed in the fuel.

An “Electron Mediated Nuclear Reaction Promoting Orbital Electron Total Energy” (EMNRPOETE) is the total energy of an electron in an EMNRPO (i.e., the total energy of an EMNRPOE). For ¹H, the EMNRPOETE may be a ZOETE and may be ˜80-81 eV. For ²H, the EMNRPOETE may be a ZOETE and may be ˜35 eV. For other EMNRPOCMs, the EMNRPOETE and or ZOETE may be different.

A “Zitterbewegung Orbital Electron Total Energy” (ZOETE) is the total energy of an electron in an zitterbewegung orbit (i.e., the total energy of an ZOE). For ¹H, the ZOETE is ˜80-81 eV. For ²H, the ZOETE is 35 eV. For other ZOCMs, the ZOETE may be different.

“Close” in terms of energy here means having an average energy difference between the average kinetic energy of a TIKEE and the EMNRPOETE, for instance the ZOETE, of a corresponding EMNRPOCM, such as a corresponding ZOOM, that is preferably less than +/−10 eV and more preferably less than +/−5 eV and more preferably less than +/−2 eV, and more preferably, less than +/−1 eV, and more preferably less than +/−0.5 eV and more preferably less than +/−0.2 eV, and more preferably less than +/−0.1 eV and more preferably less than +/−0.05 eV and most preferably less than +/−0.04 eV.

“Strong” in terms of magnetic field strength means preferably greater than 1 MTesla, and more preferably greater than 9 MTesla, and more preferably greater than 16 MTesla, and more preferably greater than 22 MTesla, and more preferably greater than 27 MTesla, and more preferably greater than 31 MTesla and most preferably approximately 32.8 MTesla.

An “Electron Mediated Nuclear Reaction Promoting Orbital” (EMNRPO) is an electron orbital that has a stronger electron-nucleus interaction than the interaction between any ordinary atomic orbitals, such as s, p, d and f orbitals and their hybridizations. Examples of EMNRPOs are highly localized, metastable and close electron-nucleus electron orbitals.

Zitterbewegung orbits are examples of EMNRPOs. EPCOs and/or EPCOEs may catalyze, enhance or otherwise promote one or more steps in an EMNR, including single electron capture and/or double electron capture.

An “Electron Mediated Nuclear Reaction Promoting Orbital Capable Material” (EMNRPOCM) is any material capable of forming and/or maintaining, for a period of time, an EMNRPO. Examples of EMNRPOCMs include, but are not limited to, light nucleus materials. Preferably, EMNRPOCMs have a nucleus, which has charge Z=1 (i.e. ¹H, ²H, ³H), thus, the resulting atom having a EMNRPO is electrically neutral, which, therefore, may more easily approach an other nucleus than a positively charged atom. A ZOCM is a type of EMNRPOCM. A reactive nuclei material may also act as an EMNRPOCM.

An “Electron Mediated Nuclear Reaction Promoting Orbital Electron” (EMNRPOE) is an EMNRPO electron in an EMNRPO around an EMNRPOCM. An EMNRPOE is a type of bound electron.

A “Zitterbewegung Orbit Capable Material” (ZOCM) is any material capable of forming and/or maintaining, for a period of time, a zitterbewegung orbit. Examples of ZOCMs include, but are not limited to, light nucleus materials. Preferably, ZOCMs have a nucleus, which has charge Z=1 (i.e. ¹H, ²H, ³H), thus, the resulting atom having a zitterbewegung orbit is electrically neutral, which, therefore, may more easily approach an other nucleus than a positively charged atom. Other ZOCMs are possible according to the invention.

A “zitterbewegung orbit electron” (ZOE) is an electron in zitterbewegung orbit around the nucleus of an atom or atomic ion. The electron may be highly localized. The electron may be in close electron-nucleus proximity. The electron may be in a metastable orbit. A ZOE is one type of highly localized, metastable and/or close electron-nucleus proximity electron.

“Light nucleus” is here defined as a nucleus having atomic number, Z, preferably 11 or less and more preferably 5 or less and more preferably 4 or less and most preferably 3 or less.

“Light nucleus material” is a material, at least in part, comprising a light nucleus. Examples include but are not limited to ¹H, ²H (D), or ³H. Light nucleus materials include any molecules, alloys or salts comprising light nucleus materials. Note that for ZOCM type EMNRPOCMs, such as ¹H and ²H, ¹H and ²H themselves can also act as a reactive nuclei material and so may fuse together with contribution of a zitterbewegung orbit or ZOE.

An “Orbit Modifying Material” (OMM) is a material, which, when combined, for example, in a molecule, alloy, salt or is otherwise in contact with one or more TIKEEOMMs, including TIKEEOMCMs, for instance as a coating or contacting surface, modifies, modulates or otherwise alters one or more electron orbitals such that the combination contains one or more TIKEEs and/or TIKEEOs. A TIKEEOM, TIKEEOMM, TIKEEOCM, TIKEEOMCM may comprise, at least in part, one or more OMMs.

An “Orbital Modified Compound Material” (OMCM) may be a combination of one or more TIKEEOMMs and/or one or more TIKEEOMCMs and/or one or more TIKEEOCMs and/or one or more TIKEEOMs and one or more OMMs. Said OMCM may be, for instance, a molecule, an alloy, a salt or any other compound material and/or a surface, coating or deposit in contact with one or more TTIKEEOMMs and/or one or more TIKEEOMCMs and/or one or more TIKEEOCMs and/or one or more TIKEEOMs. Other combinations to produce OMCMs are possible according to the invention. A OMCM may be a TIKEEOCM. A TIKEEOCM is a type of OMCM.

“Highly localized” in terms of electron orbital here means having an electron orbital probability in a narrower region than any “ordinary” atomic orbitals, such as s, p, d and f orbitals and their hybridizations. Electrons in zitterbewegung orbit may be considered to be and/or be in a highly localized state (highly localized electrons). Such highly localized ZOEs may have an average orbital distance, R, from the nucleus of preferably 0.383 pm+/−0.2 pm and more preferably 0.383 pm+/−0.1 pm and more preferably 0.383 pm+/−0.05 pm and more preferably 0.383 pm+/−0.02 pm and more preferably 0.383 pm+/−0.01 pm and more preferably 0.383 pm+/−0.005 pm and more preferably 0.383 pm+/−0.002 pm and more preferably 0.383 pm+/−0.001 pm and most preferably approximately 0.383 pm proximity around the nucleus.

“Excited” or “excited state” means any quantum state that has a higher energy than the ground state.

“Reactive nuclei” is here defined as a nuclei which participates in an electron-mediated nuclear reaction or in an electron-mediated nuclear chain reaction. Reactive nuclei may liberate energy within the overall reaction process.

Reactive nuclei may contain at least one neutron and/or one proton. Reactive nuclei may be light nuclei. A reactive nuclei may be light nuclei. Examples of reactive nuclei include, but are not limited to the nuclei of ¹H, ²H, ³H, He, Li, Be, B, C, N, O, F, Ne and Na. Ni nuclei may act as a reactive nuclei.

“Multiplication of energetic electrons” (“multiplication”) is here defined as having a larger average number energetic electrons at the process output than at the process input (the difference being the “excess electrons”). Multiplication factor is here defined as the average number energetic electrons at the process output divided by the average number energetic electrons at the process input.

“Reactive Nuclei Fuel” or “Fuel” is here defined as any material and/or mixture of materials which comprises, at least in part, reactive nuclei.

A reactive nuclei fuel may comprise one or more reactive nuclei materials, such as NDECCIs. A reactive nuclei fuel may comprise one or more EMNRPOCMs, such as ZOMCs. A reactive nuclei fuel may further comprise one or more one or more TIKEEOMs, TIKEEOCMs and/or one or more TIKEEOMMs, TIKEEOMCMs and/or one or more OMMs. A reactive nuclei fuel may be a multi-element fuel wherein one or more constituents has an electron orbital whose kinetic energy is close to the EMNRPO of an EMNRPOCM in the fuel. The reactive nuclei fuel may comprise a multi-element fuel wherein one or more constituents has an electron orbital whose kinetic energy is close to the zitterbewegung orbit total orbital energy of at least one other constituent which may be a EMNRPOCM. Said EMNRPOCM may be a ZOOM. Said ZOOM may be ¹H, ²H and/or ³H.

A “Reactive nuclei material” is any material which comprises, at least in part, one or more reactive nuclei. Reactive nuclei fuel comprises, at least in part, reactive nuclei material. An NDECCI is one type of reactive nuclei material. Reactive nuclei material may be light nuclei materials. Examples of reactive nuclei materials include, but are not limited to ¹H, ²H, ³H, He, Li, Be, B, C, N, O, F, Ne and Na. Ni may act as a reactive nuclei material. An EMNRPOCM may also act as a reactive nuclei material.

“Close electron-nucleus proximity” is here defined as an electron orbiting around a nucleus at an average distance from the nucleus of less than 100 pico-meters and more preferably, less than 10 pico-meters and most preferably, less than 5 pico-meters. The orbiting electron may be an excited electron.

Close electron-nucleus proximity electrons includes electron orbitals in “Close proximity”. Such electrons are also termed close proximity electrons, electrons in close electron-nucleus proximity or electrons in close proximity electron-nucleus states. Electrons having an electron orbital less of than 1 pm average distance and electrons in zitterbewegung orbit may be considered to be in close electron-nucleus proximity.

“Close-proximity nuclei” is here defined as two nuclei whose separation is less than 100 pico-meters and more preferably, less than 10 pico-meters and most preferably, less than 5 pico-meters.

“Excited electron” is here defined as an electron which is in a non-kinetic excitation state. The excited electron may maintain at least 85 eV, and more preferably at least 10 eV and most preferably at least 1 eV excitation energy. This excitation may last for at least 1 microsecond and more preferably for at least 10 microseconds.

A “Nuclear Double Electron Capture Capable Isotope” (NDECCI) is here defined as an atom or atomic system at least one of whose nucleus is capable of, or whose nuclei are capable of, undergoing nuclear double electron capture. The NDECCI nucleus may contain at least one proton or neutron or an isotope whose nuclei may liberate energy upon the consecutive or simultaneous nuclear capture of two or more electrons. This nuclear capture of two or more electrons may either be accomplished by a single nucleus, or by two or more close-proximity nuclei before or during the fusion process of said close-proximity nuclei. An example of an NDECCI, according to the invention is nickel (Ni). Said Ni NDECCI is capable of transmuting to Fe upon double electron capture. The exothermic energy of said double electron capture is approximately 2 MeV. Other NDECCIs and other exothermic energies are possible according to the invention. Other examples of NDECCIs include but are not limited to ⁵⁸Ni, ⁶⁴Zn, and ⁴⁰Ca and any mixture thereof. Examples of NDECCIs furthermore include but are not limited to two close-proximity protons.

“Continuous nuclear reaction” is here defined as a reaction process which produces nearly constant exothermic power output for at least one second, and more preferably for at least ten seconds, and more preferably for at least one minute and more preferably for at least 10 minutes and most preferably for at least one hour. Semi-continuous nuclear reaction is here defined as a reaction which consists of alternating phases of continuous nuclear reaction and no reaction or alternating phases of continuous nuclear reaction at two distinct power output levels.

Continuous nuclear reactions may be nuclear chain reactions.

A “net exothermic reaction” is here defined as a reaction where the sum of the individual steps in the reaction results in a net excess of energy. Thus, any single step may be endothermic, but the overall reaction may be exothermic. A net exothermic reaction may be a nuclear reaction. A nuclear reaction may be a nuclear transmutation reaction. A nuclear transmutation reaction may be the conversion of one chemical element or an isotope into another. Because any element (or isotope of one) is defined by its number of protons (and neutrons) in its atoms, i.e. in the atomic nucleus, nuclear transmutation occurs in any process where the number of protons or neutrons in the nucleus is changed. A transmutation can be achieved by nuclear reactions (in which an outside particle reacts with a nucleus). A net exothermic reaction may be a double electron capture reaction. A net exothermic double electron capture reaction may be a net exothermic double electron capture nuclear reaction. Any of the described reactions or any combination thereof may be termed a reaction.

A net exothermic reaction may be an EMNR. A single and/or double electron capture reaction may be a step in an EMNR.

A nuclear “double electron capture reaction” or “double electron capture” may be a decay mode of an atomic nucleus. For a nuclide (A, Z) with number of nucleons A and atomic number Z, double electron capture is possible if the mass of the nuclide of (A, Z−2) is lower. In this mode of decay, two of the orbital electrons may be captured by two protons in the nucleus, forming two neutrons. Two neutrinos may be emitted in the process, or in the case of simultaneous capture of two electrons, the process may be neutrinoless. Since the protons are changed to neutrons, the number of neutrons increases by 2, the number of protons, Z, decreases by 2, and the atomic mass number A remains unchanged. By changing the number of protons, double electron capture transforms the nuclide into a new element. A double electron capture reaction may be a nuclear reaction, a net exothermic double electron capture reaction, a net exothermic double electron capture nuclear reaction and/or a transmutation or a transmutation reaction.

A “high energy” or an “energetic” particle may be an energetic electron, an energetic nuclei or any other particle. High energy particles may be introduced by, e.g., ion bombardment or electron bombardment. Other methods of producing or introducing high energy particles are possible according to the invention.

High energy particles may be produced by acceleration by an electric field. Any means of applying an electric field are possible, for instance, directly applied voltage or diffusing/melting across an interface with voltage difference, for instance, while crossing interfaces with significant Fermi energy difference or acceleration by electric voltage during electrolysis. High energy particles may be introduced by phase change or fracturing withing the fuel. High energy particles may be introduced by reaction, e.g., nuclear reaction, in the fuel. High energy particles may be produced outside the reactor and/or the fuel by any means known in the art.

A “reaction” may be an electron capture reaction, including a single or double election capture reaction, a nuclear reaction and/or an electron mediated nuclear reaction.

A “reaction” may be any double electron capture reaction, which may transmute the nucleus or nuclei of, for instance, an NDECCI from one element to another. In such a reaction, the first electron capture may be endothermic, while, the second electron capture may be exothermic. In particular, the second electron capture may be more exothermic than the first electron capture is endothermic, thus, the overall reaction may be exothermic and may generate excess energy.

A “reaction” may be a sequence of electron capture and neutron capture reactions, which may transmute the nucleus of lithium isotopes from one element to another. In such a reaction, the electron capture may be endothermic, characterized by the consequent release of neutrons. The subsequent neutron capture may be exothermic. In particular, the neutron capture may be more exothermic than the first electron capture is endothermic, thus, the overall reaction may be exothermic and may generate excess energy.

A reaction may be an EMNR. Lithium may be a reactive nuclei material, a single element fuel and/or an NDECCI.

A “secondary nuclear reaction” is here defined as a nuclear reaction involving at least one of the energetic reaction products which have been kinetically energized by the double electron capture reaction.

A “chain reaction” is here defined as any reaction that perpetuates itself. An example of a chain reaction is an electron-mediated nuclear chain reaction. An exemplary chain reaction is the sequence of exothermic double electron capture reactions (nuclear transmutation reactions) where one or more NDECCI nuclei are excited by the capture of one or more electrons, to produce an excess of energetic electrons.

A “reactor” is here defined as a chamber or vessel in which fuel resides and in which the reaction takes place. A reactor may be closed or open, e.g., to a surrounding atmosphere.

All or part of the energetic electrons may be supplied externally from outside of the fuel. The externally supplied energetic electrons may be supplied by, for instance, one or more high energy particles, electromagnetic radiation, an electric current, an impact, a fracture and/or high-frequency vibration of the fuel. Electromagnetic radiation refers to the waves (or their quanta, photons) of the electromagnetic field, propagating (radiating) through space-time, carrying electromagnetic radiant energy. It includes radio waves, microwaves, infrared, (visible) light, ultraviolet, X-rays, and gamma rays.

All or part of the energetic electrons may be supplied internally from inside of the fuel. The reaction may be maintained by periodic or continuous generation of energetic electrons. A chain reaction may be maintained, at least in part, by internally supplied energetic electrons. All or part of the internally supplied energetic electrons may be from the energy released from a net exothermic reaction within the fuel and/or from melting, solidifying and/or fracturing of all or part of the fuel. The reaction may be a double electron capture reaction. Double electron capture reaction energy may maintain a chain reaction in the fuel.

Double electron capture reactions may generate at least one energetic reaction product. One or more of the energetic reaction products may maintain a chain reaction in the fuel by generating multiple energetic electrons. One or more chain reactions may be initiated by energetic atomic or sub-atomic particles. The generation of energetic reaction product may be achieved by an initiating double electron capture reaction, by high energy ion bombardment, by high energy electron bombardment, by high energy photon radiation, by neutron bombardment, or by a background neutron.

Collisions of, or other interactions with, electrons and high energy particles and/or other high energy reaction products may generate, directly or indirectly, high energy electrons. Other means of generating energetic reaction products are possible according to the invention.

The fuel may further comprise one or more modifying materials. A “modifying material” here means any material that modifies a property of the fuel. The modifying material may be a melting point modifying material, a fracture-inducing material, a material capable of sustaining excited electrons, a material causing molten/solid phases to have different Fermi levels, and/or a saturating material. Some or all of the fuel may be molten during the reaction. The NDECCI may be, for instance, ⁵⁸Ni and/or ⁴⁰ Ca. The melting point modifying material may be, for instance, Cu and/or Al. Other modifying material may be, for instance, graphite or amorphous carbon. The temperature of the fuel may be cycled within a target temperature range. The target temperature range may be the phase change temperature range of the fuel or any component thereof. According to the invention, a single element fuel also comprising a modifying material is considered a single element fuel.

Modifying materials may include, for instance, materials which modify the melting temperature (e.g. at a given pressure), here termed “melting temperature modifying materials”, the melting pressure (e.g., at a given temperature), here termed melting pressure modifying materials. Modifying materials may increase or decrease the melting temperature and/or pressure. Examples of melting point modifying materials include, but are not limited to metals which may, for instance, form an alloy with the NDECCI. An example of a metallic temperature modifying material is copper. Other temperature modifying materials are possible according to the invention. Modifying materials may include materials which modify the distribution of components in the fuel. Said materials are here termed “uniformity modifying materials”. For instance, the various components of the fuel may be, essentially, well mixed without the inclusion of said uniformity modifying material, but then segregate or tend to segregate upon the addition of said uniformity modifying material. The uniformity modifying material may be, for instance, temperature or pressure sensitive, meaning that it may segregate or tend to segregate above or below a certain temperature. A uniformity modifying material may be, for instance a saturating material. A saturating material may become saturated, for instance as the temperature is increased or decreased, in the fuel and, thus, being no longer soluble or evenly mixed, then may precipitate out of or tend to precipitate out of the other components of the fuel. An example of a saturation modifying material is lithium. Other saturation modifying materials are possible according to the invention. A temperature modifying material may also be a uniformity modifying material. Modifying materials may be fracture-inducing materials. A fracture inducing material may induce fractures within the material. A fracture-inducing material may also be in contact or in close proximity to the fuel and so may not, technically, be a modifying material as it may be external to the fuel. A fracture-inducing material may induce fractures by any means. An example means is by generating high stresses within the material. Such stresses may be rapidly released by a fracture. Stresses may be generated by, for instance, solidification, for instance during cooling. Stresses may be amplified by, for instance, lattice mismatching between material, for instance, fuel, components. A saturation modifying material or uniformity modifying material may also cause voltage differences within the fuel. In the case of a Li—Ni alloy, there may be voltage differences between the Ni-rich and Li-rich phases because of the different Fermi levels in these metallic phases. Modifying materials may sustain excited electrons in the fuel. Examples of such modifying materials are molten lithium, graphite, or amorphous carbon.

Means of supplying energetic elections may be a furnace, a particle accelerator, an electromagnetic radiation source, a current source, and/or a high frequency vibration sources. The fuel may further comprise one or more modifying materials. The modifying material may be a melting point modifying material, a material capable of sustaining excited electrons, a fracture-inducing material, a material causing molten/solid phases to have different Fermi levels, and/or a saturating material. The NDECCI may be, for instance, ⁵⁸Ni and/or ⁴⁰Ca. The melting point modifying material may be Cu and/or Al. Other modifying material may be, for instance, graphite or amorphous carbon. The device may further comprise means for cycling the temperature of the fuel within a target temperature range.

According to one embodiment of the invention, a method for energy production is described comprising the steps of providing a material, wherein at least one atomic component comprises a nuclear double electron capture capable isotope (an NDECCI) or lithium, and wherein the electron mediated nuclear chain reaction generates an excess of energetic electrons. Said material is here termed a “fuel”. Upon such reaction, an excess of energetic electrons may be produced.

By such successive transmutation of NDECCIs or lithium by said electron capture processes, a chain reaction may be sustained, leading to a useful production of energy. In order to avoid degradation of the fuel, such as by chemical reactions, the fuel may be maintained in an atmosphere which is essentially chemically inert to the reactive or to the components of the fuel.

Initiating the chain reaction may be accomplished directly or indirectly. Various exemplary means of initiation are disclosed in the following paragraphs. Other means are possible according to the invention. Indirect initiation may be accomplished by energetic ions, which in turn may produce a cascade of energetic electrons. Impacting the fuel by energetic ions, neutrons, or electrons may therefore initiate the chain reaction. An accelerating device may be used for this purpose. An example of such an accelerating device may be, for instance, a particle accelerator. The particle accelerator may be, for instance, an electrostatic particle accelerator or an electrodynamic (electromagnetic) particle accelerator. The electrodynamic (electromagnetic) particle accelerator may be, for instance, a magnetic induction accelerator, a linear accelerator or a circular or cyclic RF accelerator. Neutrons or accelerated atomic or subatomic particles may be directed to impact on or in a fuel to initiate or trigger the chain reaction.

It has been surprisingly found that energetic electrons, which may initiate a chain reaction, may be efficiently generated by at least three different methods: By the production of fractures in the solid phase of the fuel. During the fracturing process, the fuel is far from thermodynamic equilibrium. Without intending to be bound by theory, fractures are thought to be capable of generating energetic ions and/or energetic electrons near the fracture. In certain compositions of the fuel, temperature cycling has been found to be an effective method for the production of fractures. It is understood that the temperature cycling may generate mechanical stresses that, when released, may generate fractures. These mechanical stresses may be driven by the temperature gradient between the solid-liquid phases, which may also cause spatial concentration gradient of some alloy constituents.

By the solid-liquid phase changes of the fuel. During the partial melting process, the fuel undergoing a phase change may be far from thermodynamic equilibrium if the solid phase and molten phase have different Fermi energy levels. The difference in Fermi energy levels between regions may generate a voltage. This voltage may accelerate ions and electrons during phase changes. Without intending to be bound by theory, under the condition of different Fermi energy levels, partial melting events are thought to be capable of generating energetic ions and/or energetic electrons at the solid-liquid interface. In certain compositions of the fuel, temperature cycling has been found to be an effective method for the production of these solid-liquid phase changes.

By high-frequency (i.e. THz range) vibrations, which are increasing the probability of quantum tunneling.

An energetic electron may be produced, for example, from a TIKEE from a TIKEEOM and/or from a free electron having TIKE. A TIKEE in a TIKEEOM, may require only a small additional energy to transition to a EMNRPO in an EMNRPOCM, such as a ZOOM. In this case, supplying reactive nuclei kinetic energy higher than background thermal energy level. Thus, only a small excitation of a TIKEEO may be sufficient to initiate transition to EMNRPO and may, thus, catalyze, promote or otherwise enhance EMNR in a reactive nuclei material. Preferably, this additional excitation energy may be below 10 eV and more preferably, between the 1 eV to 10 eV kinetic energy range. In the case of free electrons, TIKEs may be produced by, for instance, a plasma TIKE temperatures. In one embodiment, a plasma above the TIKE temperature may be cooled or electrons may be otherwise accelerated to an energy higher than a TIKE and allowed to relax. Other methods to initiate the generation of excess energetic particles, such as energetic electrons, are possible according to the invention.

Activating a transition from nuclear chain reaction process to continuous or semi-continuous nuclear reaction process may be accomplished directly or indirectly. Various exemplary means of initiation are disclosed in the following paragraphs. Other means are possible according to the invention. It has been surprisingly found that temperature cycling is an efficient method for the activation of such transition, and for maintaining a desired rate of exothermic reaction power. Means for temperature cycling may include a control system, e.g., and electronic and/or physical control system, which may control, for instance, the power to a furnace and/or the extraction, containment and/or reflection of heat and/or radiation from or into a furnace or reactor. Consequent to the above discoveries, temperature cycling has been found to be a particularly effective method for the production of excess energetic electrons and for activating a transition from nuclear chain reaction process to continuous or semi-continuous nuclear reaction process.

### BRIEF DESCRIPTION OF THE SEVERAL VIEW OF DRAWINGS

Further advantageous features and details of the various embodiments of this disclosure will become apparent from the ensuing description of preferred exemplary embodiments and with the aid of the drawings. The features and combinations of features recited below in the description or in the drawings alone, may be used not only in the particular combination recited, but also in other combinations on their own, without departing from the scope of the disclosure.

In the following, advantageous examples of the invention are explained with reference to the accompanying figures, wherein:

FIG. 1. A process flow of an electron-mediated nuclear chain reaction process when the fuel comprises NDECCI nuclei. Stars indicate excited states.

FIG. 2. A process flow of an electron-mediated nuclear chain reaction process when the fuel comprises lithium. Stars indicate excited states.

FIG. 3. A process flow of energetic electron multiplication.

FIG. 4. Temperature versus time (seconds) measurement of heating 2 g constantan alloy together with 0.06 g lithium. The rapid exothermic events are indicated by circles. Electromagnetic emissions from non-exothermic processes, which appear as noise, are observable in-between.

FIG. 5. Temperature evolution of a fuel sample during the heating phases of temperature cycling, prior to the onset of a continuous nuclear reaction. The horizontal axis shows the elapsed seconds from the start of heating phase, and the vertical axis shows the measured temperature. The figure shows the overlay of the six cycles preceding the transition to a continuous nuclear reaction.

FIG. 6. Temperature evolution of a fuel sample during the heating phases of temperature cycling, after to the onset of a continuous nuclear reaction. The horizontal axis shows the elapsed seconds from the start of heating phase, and the vertical axis shows the measured temperature. The figure shows the overlay of the six cycles after the transition to a continuous nuclear reaction, starting from the point of transition.

FIG. 7. Overlay of temperature evolution charts from FIGS. 6 (dashed lines) and 7 (solid lines). The horizontal axis shows the elapsed seconds from the start of heating phase, and the vertical axis shows the measured temperature. The overlay visualizes the continuous exothermic power production by the fuel sample. The external heating power is 1.2 kW.

FIG. 7a. Temperature (° C.) versus time (s) charts during transition from pulsed to continuous process with Ni—Cu—Li fuel mixture showing the cooling phases (zero heating power). The labels indicate cycle no. relative to the starting of continuous reaction.

FIG. 8. Schematic of an embodiment of an apparatus according to the invention

FIG. 9. Visualization of the toroidal electron structure of a zitterbewegung orbit. R is the reduced Compton wavelength, and r is the charge radius.

FIG. 10. Autocorrelation frequency spectrum during the continuous reaction process with Ni—Cu—Li fuel mixture. Top: the spectrum prior to the continuous reaction. Bottom: the spectrum during the continuous reaction.

FIG. 11. Temperature and heating power evolution of a reactor containing Li—Ni—Al fuel composition. The top curve shows the temperature (° C.) at the fuel container, the middle curve shows the temperature (° C.) at the edge of reactor, and the bottom curve shows the applied heating power (W). The horizontal axis indicates the elapsed time (seconds).

FIG. 12. Illustration of the equivalence between instantaneous electron speed vectors in the case of purely wave-like zitterbewegung rotation (V_{wave}) land the particle-like case of composition between kinetic plus wave-like zitterbewegung rotations (Cₑₘ).

FIG. 13. Illustration of the Fermi level difference between solid/molten phases in an experiment (left) and the ion flux into the accelerating region during melting (right)

FIG. 14: Illustration of a stabilized electron orbital. The gray ring represents the electron's zitterbewegung orbit, the arrows represent magnetic field lines, and the center rings represent the proton's processing zitterbewegung motion.

FIG. 15: Eₜₒₜₐₗ and ΔE values obtained prior to taking into account the Lorentz force effect

FIG. 16 Eₜₒₜₐₗ and ΔE values obtained after also taking into account the Lorentz force effect.

FIG. 17: Examples of fuels according to certain embodiments of the invention.

FIG. 18: Schematic diagram of various exemplary means of modulating an electron orbital of a EMNRPOCM, such as a ZOOM, by the addition or removal of an OMM.

FIG. 19: A Ven diagram of the relationship between some the various materials that may be present in a reactive nuclei fuel according to the invention.

FIG. 20: A method for producing EMNRs according to one embodiment of the invention.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

Here, we disclose a new fuel, method and apparatus for producing EMNRs. Disclosed is a method and apparatus utilizing excited electron and/or highly localized states, such as close electron-nucleus proximity electrons and/or electron orbitals, to generate nuclear reactions. The electron orbitals may be metastable, highly localized around and/or in close electron-nucleus proximity to a nucleus (i.e. EMNRPOs). The nucleus may be a light nucleus, for instance, a ¹H, ²H or ³H nucleus. The process may be used to generate nuclear reactions, including nuclear chain reactions and/or ENMRs, including ENMCRs. The reaction my comprise a pulsed reaction phase and/or an essentially continuous reaction phase. The pulsed reaction phase and/or the continuous reaction phase may involve chain reactions. The process may transition between pulsed to continuous phases. These reaction phases may appear as two distinct phases. One or more of the reaction phases may be heat and/or energy producing. A process for electron transition into one or more EMNRPOs is disclosed. With respect to application, the discovered method and apparatus offers the possibility of sustainable energy production from fuels comprising light nuclei materials, e.g., ¹H or ²H, and reactive nuclei materials, such as metals, e.g. ²H, ¹H, ³H, He, Li, Be, B, C, N, O, F, Ne Ni and Na. Other light nuclei materials and reactive nuclei materials are possible according to the invention.

Detailed embodiments of the present invention are disclosed herein with the reference to accompanying drawings. A method for energy production from an electron-mediated and/or single-element nuclear reaction is described. The method may comprise the steps of:

a) loading a reactive nuclei fuel into a reactor; and
b) initiating and/or periodically re-initiating one or more chain reactions in the fuel and/or continuously or semi-continuously supplying electromagnetic radiation onto the fuel.

The method may further comprise the step of; c) activating a transition from an initial or periodically re-initiated nuclear chain reaction to continuous or semi-continuous nuclear reaction. The fuel may have a fuel structure with a multiplication factor of energetic electrons larger than one and/or the fuel is thermally activated. The supplied electromagnetic radiation may have sufficient energy to catalyze the formation of close electron-nucleus proximities. The supplied electromagnetic radiation may be produced by, for instance, a melting phase change.

The reactive nuclei fuel may comprise one or more nuclear double electron capture capable isotopes. At least one nuclear double electron capture capable isotope may be ⁵⁸Ni. Two of the reactive nuclei may comprise a mixture of ⁶Li and ⁷Li isotope nuclei. The ratio of ⁶Li to ⁷Li isotopes may be between 0.001:0.999 and 0.999:0.001. The initiation and/or periodic re-initiation of the electron-mediated nuclear chain reaction and/or melting phase change may be accomplished by temperature cycling within a target temperature range and/or by supplying energetic particles and/or neutrons to the fuel. The energetic particles may be energetic electrons and/or neutrons. The fuel may comprise a fuel component, which is capable of cracking or fracturing upon being heated in a molten alkali or non-alkali environment. The molten alkali environment may comprise molten lithium.

According to one aspect of one embodiment of the invention, an electron orbital which allows much stronger electron-nucleus interaction than ordinary interactions between one or more inner shell electron and the nucleus of an atom may be utilized. These orbitals may be EMNRPOs. Close electron-nucleus proximity, metastable and/or a highly localized electrons are examples of such orbitals. Utilizing EMNRPOs may enhance the probability of electron capture and/or may catalyze, promote or otherwise enhance fusion reactions, such as EMNRs, including EMNCRs. According to one embodiment of the invention, said EMNRPOs may allow a small inter-nuclei distance between such quasi-neutron and some other nucleus, thereby enabling catalyzed fusion reactions such as EMNRs, including EMNCRs. Said EMNRPOs may catalyze, enhance or otherwise promote EMNR, including single or double electron capture or other nuclear reaction processes. The reaction may generate energetic particles, such as energetic ions and/or energetic electrons or other energetic charged particles. The generated energetic particles may promote a chain reaction, either directly as energetic electrons that participate in EMNR, including electron capture, or indirectly, for instance, by colliding with electrons, or generating electron orbitals, such as EMNRPOs, that may generate, catalyze, enhance or otherwise promote energetic electrons which may participate in EMNR, including electron capture.

The fuel may be a reactive nuclei fuel comprising, at least, reactive nuclei material. A fuel may be a multi-element fuel. The fuel may comprise one or more additional constituents, e.g. one or more TIKEEOMs, TIKEEOMMs, TIKEOCM and/or a TIKEEOMCM, that may have an electron orbital whose kinetic energy is close to, or can be modified to be close to, one or more EMNRPO total orbital energy of one or more EMNRPOCMs in the fuel. One or more of the EMNRPOs may be a zitterbewegung orbits. One or more of the EMNRPOCMs may be ZOCMs. The reactive nuclei fuel may comprise, for instance, hydrogen and/or deuterium nuclei as exemplary EMNRPOCMs or ZOCMs. Other reactive nuclei fuels are possible according to the invention.

According to one embodiment of the invention, an exothermic nuclear reaction may be enabled by a magnetic field. The magnetic field may be a strong magnetic field. The magnetic field may be highly localized around, or be in close proximity to, a reacting nucleus. The magnetic field may be created, for instance, by an electron in an EMNRPO. The EMNRPO may be a zitterbewegung orbit. The electron in EMNRPO may be in orbit around the reacting nucleus or a nucleus in close-proximity, i.e., a close-proximity nucleus. The magnetic field may be created by a magnetic monopole. The magnetic monopole may be generated by, for instance, shining light onto ferromagnetic nanoparticles. The magnetic field may be created by a current pulse. The current pulse may be generated by, for instance, capacitor bank discharge. The current pulse may be sufficiently strong so as to generate a strong magnetic field in close proximity to the reacting nucleus. According to one embodiment of the invention, the reaction may comprise an exothermic rearrangement of one or more nuclear bonds within the fuel. According to one embodiment of the invention, the reaction may comprise an exothermic rearrangement of one or more nuclear bonds within the fuel. According to one embodiment of the invention, the reaction may comprise an exothermic breakup of one or more nuclear bonds within the fuel. According to one embodiment of the invention, the reaction may comprise an exothermic breakup of one or more nucleons within the fuel. According to one embodiment of the invention, a nucleon can be destabilized by a strong magnetic field. The magnetic field may be the magnetic field in the center of EMNRPO. The EMNRPO may be a zitterbewegung orbit. An EMNROE, such as a ZOE, may create a magnetic dipole. The strength of magnetic field is preferably greater than 1 MTesla, and more preferably greater than 9 MTesla, and more preferably greater than 16 MTesla, and more preferably greater than 22 MTesla, and more preferably greater than 27 MTesla, and more preferably greater than 31 MTesla and most preferably approximately 32.8 MTesla at its center (where the nucleus is). The strength of magnetic field at the center of a zitterbewegung orbit is approximately 32.3 Mega Tesla. The nucleon may be a proton. Such magnetic proton destabilization may release 938 MeV.

All or part of the high energy electrons may be supplied externally from outside of the fuel and/or reactor. The externally supplied high energy electrons may be supplied by one or more high energy particles, electromagnetic radiation, an electric current, an impact and/or high-frequency vibration of the fuel. All or part of the high energy electrons may be supplied internally from inside of the fuel and/or the reactor. A reaction may be maintained by periodic or continuous generation of high energy electrons. All or part of the internally supplied high energy electrons may be released from one or more reactions within the fuel and/or from melting, solidifying and/or fracturing of all or part of the fuel. The reaction may maintain a chain reaction in the fuel. The double electron capture reaction may generate at least one energetic reaction product. The generation of energetic reaction product may be achieved by an initiating double electron capture reaction, by high energy ion bombardment, by high energy electron bombardment, by high energy photon radiation, by neutron bombardment, and/or by a background neutron. The fuel may further comprise one or more modifying materials. A modifying material may be a melting point modifying material, a fracture-inducing material, a material causing molten/solid phases to have different Fermi levels, and/or a saturating material. Some or all of the fuel may be molten during the reaction. The target temperature range may be the phase change temperature range of the fuel or any component thereof. A reaction and/or chain reaction may be initiated and/or sustained spontaneously or intentionally.

An apparatus for energy production from an electron-mediated and/or single-element nuclear chain reaction is described. The apparatus may comprise:

a) a reactor containing a reactive nuclei fuel; and
b) means for initiating and/or periodically re-initiation the chain reaction in the fuel and/or continuously or semi-continuously supplying electromagnetic radiation onto the fuel.

The apparatus may further comprise means of; c) activating a transition from an initial or periodically re-initiated nuclear chain reaction to continuous or semi-continuous nuclear reaction. The fuel may have a fuel structure with a multiplication factor of energetic electrons larger than one and/or the fuel be thermally activated. The supplied electromagnetic radiation may have sufficient energy to catalyze the formation of close electron-nucleus proximities. The supplied electromagnetic radiation may be produced by, for instance, a melting phase change.

The reactive nuclei fuel may comprise one or more nuclear double electron capture capable isotopes. At least one nuclear double electron capture capable isotope may be ⁵⁸Ni. Two of the reactive nuclei may comprise a mixture of ⁶Li and ⁷Li isotope nuclei. The ratio of ⁶Li to ⁷Li isotopes may be between 0.001:0.999 and 0.999:0.001. The initiation and/or periodic re-initiation of the electron-mediated nuclear chain reaction and/or melting phase change may be accomplished by temperature cycling within a target temperature range and/or by supplying energetic particles and/or neutrons to the fuel. The energetic particles may be energetic electrons and/or neutrons. The fuel may comprise a fuel component, which is capable of cracking or fracturing upon being heated in a molten alkali or non-alkali environment. The molten alkali environment may comprise molten lithium. The initiation or sustaining of a reaction and/or chain reaction may rely on a spontaneous initiation and/or sustaining event or may rely on an intentional initiation or sustaining source, for instance, of heat energy and/or energetic particles.

FIG. 20 describes a method for producing an EMNR (33) according to one embodiment of the invention. In the method, one or more TIKEEs (30) are supplied to a fuel (28) comprising one or more reactive nuclei materials (25) and one or more EMNRPOCMs (23). The fuel (28) may be in a reactor (1). One or more of the TIKEEs (30) may be bound (30a) in a TIKEEO (29) of a TIKEEOM (16) or may be unbound (30b). One or more of the TIKEEs (30) may transition (32) to one or more of the EMNRPOs (24) of one or more of the EMNRPOCMs (23) in the fuel (28), thereby becoming an EMNRPOE (31), which then may catalyze, enhance or otherwise promote one or more EMNRs (33) in one or more reactive nuclei (34) of one or more reactive nuclei materials (25) in the fuel (28). It is important to note that, for unbound TIKEEs, (30b) it is the relative motion between an EMNRPOCM (23) and an unbound electron that defines the effective kinetic energy. Thus, an unbound TIKEE (30b) may be stationary relative to a moving EMNRPOCM (23). One or more of the bound TIKEEs (30a) may be transitioned to one or more EMNRPOs (24) in one or more EMNRPOCMs (23) by, for instance, diffusing one or more EMNRPOCMs (23) through a material comprising TIKEEOMs (16), accelerating one or more EMNRPOCMs (23) into a material comprising TIKEEOMs (16) and/or accelerating one or more TIKEEOMs (16) into a material comprising EMNRPOCMs (23). One or more of the EMNRPOCMs (23) and/or TIKEEOMs (16) may be accelerated, for instance, by surface plasmons, surface voltage during electrolysis, fracturing and/or by Fermi-level difference across a surface interface. The Fermi-level difference may be generated by, for instance, a melting phase change and/or a fracture. The melting phase change and/or fracture may be generated by, for instance, temperature cycling within a target temperature range. The target temperature range may be bounded within 100° C. of each the fully solid and fully molten states of all or part of the fuel. Electrons may be transitioned to EMNRPO by one or more unbound TIKEEs. One or more of the unbound TIKEEs (30b) may be supplied by, for instance, providing a plasma comprising one or more EMNRPOCMs (23), wherein the plasma temperature is within +/−10 eV of one or more of the EMNRPOETEs of one or more of the EMNRPOs (24) in the fuel and/or bombarding a fuel comprising EMNRPOCMs (23) with electrons with kinetic energies within +/−10 eV one or more of the EMNRPOETEs of one or more of the EMNRPOs (24) in the fuel. Electrons may be transitioned to EMNRPO by bombarding a fuel (28) comprising EMNRPOCMs (23) with ions, preferably EMNRPOCM (23) ions, with kinetic energies within +/−10 eV of three times (3×) the EMNRPOETE of one or more of the EMNRPOs (24) in the fuel (28). One or more of the EMNRPOCMs (23) may be a ZOOM and/or one or more of the EMNRPOs (24) may be a zitterbewegung orbit. One or more EMNRPOEs (31), such as ZOEs, may be supplied by transitioning (32) one or more TIKEEs (30) with kinetic energies within 10 eV of 80-81 eV to an EMNRPO (24) of one or more EMNRPOCMs, such as ZOCMs, comprising ¹H and/or transitioning (32) one or more TIKEEs (30) with kinetic energies within +/−10 eV of 35 eV to an EMNRPO (24), such as a zitterbewegung orbit, of one or more EMNRPOCM, such as ZOCMs, comprising ²H. In the case of a ²H ZOCM, an EMNR can by occur in itself (33a).

FIG. 8 describes an embodiment of the device comprising a reactor (1) containing the fuel (2) and means (3) of supplying energy (4) to the reactor (1), which may then, supply energy (11) to the fuel, or means (5) of supplying energy (6) directly to the fuel (2). The energy may be e.g. thermal energy, energetic particles, energetic radiation, etc. The energy and/or energetic particles and/or radiation may be supplied by any means known in the art, for instance by resistive heating, microwave heating, chemical reaction, particle generators and/or accelerators etc. The energetic particles may be energetic electrons. The energy and/or energetic particles and/or radiation may be supplied continuously, intermittently and/or periodically. The energy and/or energetic particles and/or radiation may be used to initiate, reinitiate and/or maintain the reaction in the fuel. The reaction in the fuel may generate energy and/or energetic particles and/or radiation which may be captured within the fuel (9) which may initiate, re-initiate and/or maintain the reaction in the fuel. The reaction in the fuel may generate energy and/or energetic particles and/or radiation which may not be captured within the fuel (10) which may not initiate, re-initiate and/or maintain the reaction in the fuel and may escape the reactor and be used for useful work or energy or power generation outside the reactor (1). The supplied energy (4,6) or changes in the supplied energy (4,6) may create liquid regions (7) within the fuel or fractures (8) within the fuel. These fractures and/or melting and/or solidifying liquid regions may generate and/or release energy and/or energetic particles and/or radiation within the fuel.

The apparatus may comprise a means of supplying initiation energy. The means may be, but is not limited to, a furnace, a particle accelerator, an electromagnetic radiation source, a current source and/or a high frequency vibration source. The fuel may further comprise one or more modifying materials. A modifying material may be a melting point modifying material, a fracture-inducing material, a material causing molten/solid phases to have different Fermi levels, and/or a saturating material. The target temperature range may be the phase change temperature range of the fuel. The apparatus may comprise a vessel for containing a fuel. The apparatus may further comprise means for maintaining a chemically inert environment around the fuel. The apparatus may further comprise means for cycling the temperature of the fuel within a target temperature range.

Means for cycling the temperature may include a temperature or radiation sensor, a power supply for supplying power to heat or otherwise supply energy to the reactor fuel and a controller for varying the power to a reactor (e.g. furnace) and/or fuel or energetic particle source or any other employed heat, radiation or energy source, or for varying the rate or amount of heat, radiation and/or energy released from and/or reflected back to the reactor and/or fuel. Other means of cycling are possible according to the invention.

The modifying material may be, for instance, EMNRPOCM, such as a ZOOM, and/or a TIKEEOM, a TIKEEOMM, a TIKEOCM and/or a TIKEEOMCM and/or an OMM.

The method and/or the apparatus described may be used for generating heat, radiation, power and/or energy. The heat, radiation, power and/or energy generated may be used in an electric vehicle, an electrical or electronic device, a power or energy unit or plant, a backup power or energy unity or a grid storage or stabilization unit. Other uses of the heat, radiation, power and/or energy are possible according to the invention.

Heat, energy, radiation and/or pressure generated by the method and/or apparatus may be converted to useful power or energy by any means known in the art. The heat or energy can be used directly or converted to another form of energy. The fuel may be arranged to achieve a multiplication factor greater than one.

Arranging a fuel in such configuration that the multiplication factor of energetic electrons becomes larger than one here means that at least some parts of the fuel become chain reaction capable, characterized by an increasing number of energetic electrons during the course of said chain reaction.

Disclosed are certain fuels for nuclear reaction. The nuclear reaction may be an EMNR. The fuel may be suitable for initiating and/or sustaining nuclear reaction. The fuel may comprise one or more reactive nuclei. A fuel my comprise a metal. The metal may be a pure metal, and alloy and/or a metal containing molecule. The metal may comprise one or more reactive nuclei. The fuel may comprise one or more materials comprising EMNRPOs and/or TIKEEOs. The metal in the fuel may be Ni or Ni containing materials.

For nickel based fuels, these configurations may comprise low density materials, such as nickel hydride, Li-rich molten alloy comprising Ni and Li, etc. For lithium, these configurations may comprise large molten regions, i.e. large with respect to the mean diffusion distance of free neutrons, minimizing the out leakage of neutrons. Preferably, the molten region's minimum dimension is greater than the mean diffusion distance of free neutrons and more preferably greater two times the diffusion distance.

According to one embodiment of the invention, the fuel may comprise or further comprise EMNROCM, such as light nuclei materials, such as hydrogen and/or deuterium. It has been surprisingly found that EMNRs can be achieved by electron orbitals which may allow much stronger electron-nucleus interaction than the ordinary interaction between the inner shell electrons and the nucleus. EMNRPOs are examples of such strong electron-nucleus interaction orbitals. It has been surprisingly found that EMNRPOs may catalyze, enhance or otherwise promote the probability of EMNR, including electron capture. Most importantly, it has been surprisingly found that EMNRPOs, such as zitterbewegung orbits, allow small inter-nuclei distances between such quasi-neutron and another nucleus, which may enable catalyzed fusion reactions, including EMNR.

a) A fuel may comprise one or more EMNRPOCMs. A fuel, a reactor containing the fuel and/or a process utilizing the fuel may promote the transition of electrons to EMNRPOs around EMNRPOCMs within the fuel. Examples include, but are not limited to: including in the fuel one or more materials having, or which can be modified to have, an electron orbital having a kinetic electron energy close to the EMNRPOETE of the employed EMNRPOCM (i.e., a TIKEEOM, a TIKEEOMM, a TIKEOCM and/or a TIKEEOMCM); and
b) maintaining the fuel in the reactor, for at least part of the reactor operating time, at a temperature where the average kinetic electron energy of at least one electron orbital of a TIKEEOMM or TIKEEOM is close to the one or more of the EMNRPOETEs of one or more of the employed EMNRPOCMs.

The transition to EMNRPO may, in certain embodiments, be further promoted by:

c) including in the fuel one or more OMMs which modulate or otherwise modifies, the transition probability of energetic electron reaction products into EMNRPOs around one or more of the employed EMNRPOCMs.

The EMNRPOCM may be a ZOOM. An EMNRPO may be a zitterbewegung orbit. A purpose of promoting the transition to EMNRPOs, such as zitterbewegung orbits, is to enable a multiplication factor of energetic electrons, preferably to a factor greater than one. The creation of a EMNRPO, such as a zitterbewegung orbit, may then, directly or indirectly, release one or more electrons carrying away nuclear reaction energy. Said electron may be an energetic electron. Said electron may create one or more new EMNRPOs, such as zitterbewegung orbits. If the product of the number of electrons and the probability of said released electrons is greater than one, the multiplication factor may be greater than one.

A EMNRPOCM, such as a ZOOM, may have a light nucleus or may be a light nuclei material. The light nucleus may be a Z=1 nucleus, where atomic number, Z, is the number of protons in the nucleus. Examples of Z=1 nuclei materials include, but are not limited to ¹H (having a p as its nucleus), ²H (D) and/or ³H. The fuel may comprise one or more materials having an electron orbital having a kinetic electron energy close to the EMNRPOETE of an employed EMNRPOCM, such as the zitterbewegung orbit of an employed ZOOM. Said material is a TIKEEOM. An EMNRPOCM may be a TIKEOM and/or a TIKEOMM.

A reactive particle, such as a reactive nucleus or a reactive nucleus material, may be generated in a fuel wherein one or more constituent has an electron orbital whose kinetic energy is close to the zitterbewegung orbital total orbital energy. i.e., the fuel may contain an EMNRPOCM, such as a ZOOM, and a corresponding and/or matching TIKEEOM.

ATIKEEOM may be supplied to, or produced in, the fuel. ATIKEEOM that already comprises an electron in a TIKEEO may be further modified by, for instance one or more OMMs to optimize one or more orbitals. Such a TIKEEOM may then be considered a TIKEEOMM. ATIKEEOMM that does not comprise an electron in a TIKEEO may be combined with one or more OMMs to produce an OMCM, which may then be a TIKEEOCM and which may be a TIKEEOM. The combining may be done before introducing into the fuel into the reactor or may be done in-situ in the reactor. Combining may be by any means, including but not limited to, chemically reacting, alloying (e.g. of two or more metals), contacting a deposit (e.g. a surface deposition of hetero-atoms, or surface deposition of hetero-molecules) or by any other means. A combination may be in the form of, for instance, a molecule, a salt or an alloy or being put in contact with a surface, coating or deposit. Other combinations and methods of combining are possible according to the invention. A molecular combination may be, for instance, a borate, a boride, an oxide, a nitride, a nitrate, an oxide, a fluoride, a silicate, a phosphate, a sulfate, a chloride, a selenide, a bromide, an iodide, a nitrate, a nitride, a phosphate, a phosphine, a phosphide, a sulfate or a sulfide. Other molecular combinations are possible according to the invention. A fuel may comprise a plurality of TIKEEOMMs, TIKEEOMs, OMCMs and/or OMMs, or any mixture thereof.

FIG. 17 shows examples of fuels according to certain embodiments of the invention. According to one embodiment of the invention, a fuel (28) for nuclear reaction may comprise one or more EMNRPOCMs (23), wherein the one or more EMNRPOCMs (23) are materials capable of forming and/or maintaining, for a period of time, one or more EMNRPOs (24), wherein the one or more EMNRPOs have a stronger electron-nucleus interaction than the electron-nucleus interaction between any s, p, d and f orbitals and their hybridizations of the EMNRPOCMs (23). The nucleus (26) may or may not comprise a neutron and may or may not comprise ordinary orbital electrons (not shown). Though EMNRPOCMs (23) are, by definition, capable of having EMNRPOs (24), before reaction begins, EMNRPOCMs (23) may not comprise any EMNRPOs (24). A fuel for nuclear reaction may comprise one or more reactive nuclei materials (25), wherein said reactive nuclei materials comprise a nucleus (26) having at least one neutron (27) and/or proton (35), i.e., the formation of an EMNRPO may initiate a reaction. The fuel may further comprise one or more TIKEEOMs (16) comprising at least one TIKEEO (29) having at least one TIKEE (30) having a TIKE within +/−10 eV of the EMNRPOETE of one or more EMNRPOEs (not shown) of one or more EMNRPOs (24) of one or more of the EMNRPOCMs (23) in the fuel (28) and/or one or more of the reactive nuclei materials (25) may be an NDECCI. One or more of the TIKEEOMs (16) may be a TIKEEOCM comprising one or more TIKEEOMs (16), and/or one or more TIKEEOMMs (not shown) and/or one or more TIKEEOMCMs (not shown). The fuel may further comprise a modifying material (not shown). The modifying material may be an OMM, a melting point modifying material, a fracture-inducing material, a material capable of sustaining excited electrons, a material having different Fermi levels in the molten and solid phases, and/or a saturating material. One or more of the EMNRPOCMs (23) may comprise a light nucleus material having an atomic number, Z, less than to 10. One or more of the light nucleus EMNRPOCMs (23) may comprise a material having an atomic number, Z, equal to 1. One or more of the material having an atomic number, Z, equal to 1 may comprise ¹H, ²H and/or ³H and any combination thereof. One or more of the reactive nuclei materials (25), TIKEEOMs (16), TIKEEOMMs, TIKEEOCMs and/or TIKEEOMCMs may comprise a metal. One or more TIKEEOMs (16), TIKEEOMMs, TIKEEOCMs and/or TIKEEOMCMs are part of, chemically bonded to, alloyed with, or are otherwise in contact or close proximity with, an OMM so as to form a TIKEEOCM. One or more of TIKEEOCMs may be molecules, alloys or salts comprising one or more TIKEEOMMs and/or TIKEEOMCMs and one or more OMMs and/or a surface or coating of OMM in contact with one or more TIKEEOMMs and/or TIKEEOMCMs. One or more of the EMNRPOCMs (23) may be ZOCMs. One or more of the TIKEEOMs (16) may comprise Cr, Cu, Ca, O, Ni, Co, Br or V and/or one or more of the ZOCMs may comprise ¹H, ²H and/or ³H. One or more of the ZOCMs may comprise ¹H and one or more of the TIKEEOMs may comprise at least one TIKEE (30) in a TIKEEO (29) with a TIKE with a kinetic energy within +/−10 eV of the ¹H ZOETE of 80-81 eV. One or more of the TIKEEOMs (16) may comprise Ni, Br, Ca, 0, Co, Cu, Cr and/or V. One or more of the ZOCMs may comprise ²H and one or more of the TIKEEOMs (16) may comprise at least one TIKEE (30) in a TIKEEO (29) with a TIKE having a kinetic energy within +/−10 eV of the ²H ZOETE of 35 eV. One or more of the TIKEEOMs (16) and/or TIKEOCMs may comprise Ca and/or O. At least one of the reactive nuclei materials may be, for instance, ¹H, ²H, ³H, He, Li, Be, V, C, N, O, F, Ne and/or Na and/or at least one of the NCECCIs may comprise ⁶Li and ⁷Li, ⁵⁸Ni, ⁶⁴Zn, or ⁴⁰Ca or any combination thereof. One or more of the modifying materials may comprise Cu and/or Al.

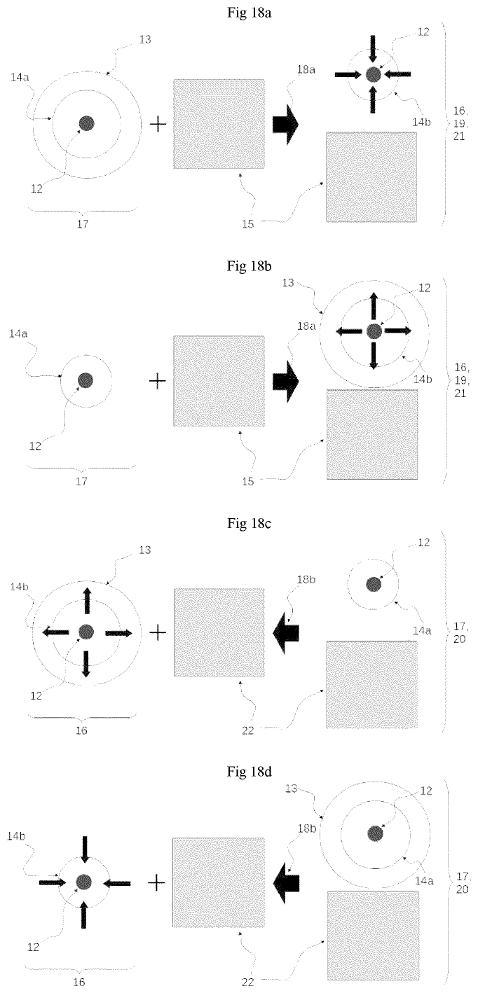

The energy of an orbital in a material, e.g. a TIKEEOM, a TIKEEOMMs, an OMCM, a TIKEEOMCM, and/or a TIKEEOCM, may be changed by the removal and/or addition of, for instance, outer electrons. Removal or addition can be partial removal and/or addition, i.e. in a chemical bond, an electron may not fully removed, just its probability distribution changes around one or more of its nuclei. Removing outer electrons may increase the kinetic energy of a remaining electron orbital. Adding one or more outer electrons may decrease the kinetic energy of a remaining electron orbital. According to one embodiment of the invention shown schematically in FIG. 18a, corresponding to process direction 18a, a TIKEEOMM (17) having one or more nuclei (12) and one or more electron orbitals (14a), which may be inner electron orbitals, and which may not have a TIKE of a corresponding EMNRPOCM, such as a ZOOM, in the fuel such that it could be considered a TIKEEOM, is combined with one or more OMMs (15) to form an OMCM (19). The combination of TIKEEOMM (17) and OMM (15) may cause a change in one or more of said inner electron orbitals (14a shifting to 14b), for instance, such that its kinetic energy is, for at least some period of time, a TIKE close to the EMNRPOETE of a corresponding EMNRPOCM, such as a ZOOM, in the fuel, such that OMCM (19) may become a TIKEEOCM (21). The combination thereby may become a type of TIKEEOM (16). In this example embodiment, one or more outer elections (13) are removed and said inner electron's (14a shifted to 14b) average position is moved closer to nucleus, resulting in decreased potential energy and increased kinetic energy. Conversely, the example embodiment of FIG. 18b, is similar to the example of FIG. 18a, except one or more OMMs (15) may be used to add one or more outer electron orbitals (13), to move said inner electron's average position is farther from the nucleus (14a shifting to 14b), resulting in increased potential energy and decreased kinetic energy.

Similarly, as shown in FIG. 18c, a separating process can be used according to process direction 18b, wherein the TIKEEOMM (17) is a TIKEEOMCM (20) having one or more nuclei (12), one ore more electron orbitals (14a) that may not have a TIKE of a corresponding EMNRPOCM, such as a ZOOM, in the fuel, such that it could be considered a TIKEEOM (16), is separated from one or more TIKEEOMCM sub components (22). In this example embodiment, an outer electron orbital (13) is added to move the inner electron orbital farther from the nucleus (14a shifting to 14b), thus, creating a TIKEEOMCM sub component (22) and a TIKEEOM (16) from a TIKEEOMM (17), which, in this case, is a TIKEEEMCM (20). Conversely, the example embodiment of FIG. 18d, which is similar to the example of FIG. 18c, except that an outer electron orbital (13) is removed to move the inner electron orbital farther from the nucleus (14a shifting to 14b), shows a TIKEEOM (16) produced from a TIKEEOMM (17), which, in this case, is a TIKEEEMCM (20).

Said combinations with and/or separations may be achieved by any means, according to the invention, including but not limited to, chemical reaction with, surface deposition on, or particle or photon bombardment. Said combination or separation is generally termed “modifying interaction”. A “modifying interaction” may modify one or more TIKEEOMMs such as a TIKEEOMCM so that it becomes a TIKEEOM, such as a TIKEEOCM.

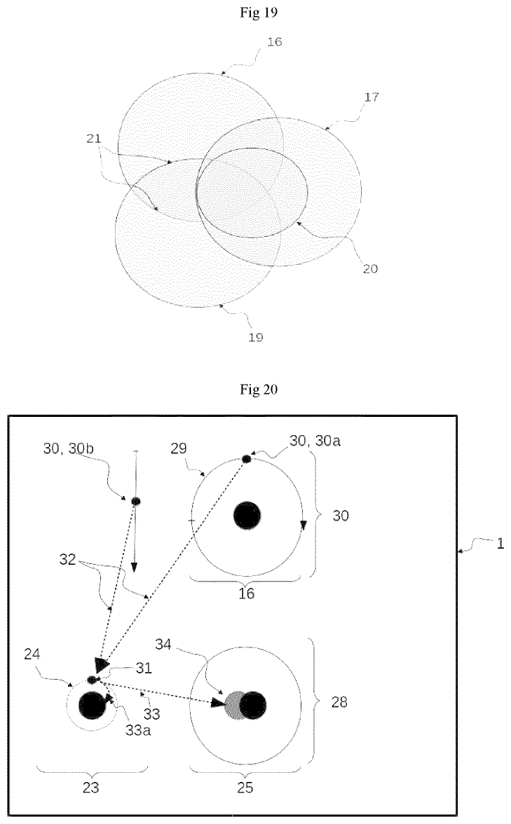

FIG. 19 shows a Ven diagram of the relationship between some the various materials that may be present in a reactive nuclei fuel according to the invention. In general, some TIKEEOMs (16) may also be TIKEEOMMs. In general, some TIKEEOMMs (17) may also be TIKEEOMs (16). In general, some OMCMs (19) may be TIKEEOMs (16). I general, some OMCMs (19) may be TIKEEOMs (16). In general, some TIKEEOMMs (17) may be OMCMs (19). In general, some OMCMs (19) may be TIKEEOMMs (17). In general, some TIKEEOMs (16) may also be TIKEEOMCMs (20). In general, some TIKEEOMCMs (20) may also be TIKEEOMs (16). In general, some TIKEEOMCMs (20) may be OMCMs (19). In general, some OMCMs (19) may be TIKEEOMCMs (20). In general, all TIKEEOMCMs (20) are TIKEEOMs (16). In general, some TIKEEOMs (16) may be TIKEEOCMs (21). In general, all TIKEEOCMs (21) are TIKEEOMs (16). In general, some TIKEEOMs are OMCMs (19). In general, all TIKEEOCMs (21) are OMCMs (19). A TIKEEOCM (21) may be a TIKEEOM (16). The TIKEEOMM (17), the TIKEEOM (16) and/or the OMM (15) may be, for instance, an atom, molecule, coating, deposit, alloy, salt or any other form of matter or combinations of forms of matter. The TIKEEOCM (21) or TIKEEOMCM (20) may be, for instance, a molecule, salt, alloy, coating and/or deposit. The combination may be a chemical bond, a physical contact or other combination incorporating the OMM (15). An compound that contains one or more TIKEEOs (29) may then be termed a TIKEEOM (16).

An invention comprising a method and an apparatus for energy production comprising heating a fuel to initiate and/or sustain an exothermic reaction in the fuel is disclosed. According to one embodiment of the invention, the one or more elements of fuel may be an alkali metal, an alkali earth metal, a transition metal, a post-transition metal, a lanthanide and/or an actinide.

A mechanism for high probability nucleus-to-electron energy transfer for the production of energetic electrons is disclosed. According to one embodiment of the invention, electrons may carry away fusion energy in some, most or all nuclear reactions. Said energy transfer may be the result of certain orbitals with close electron-nucleus proximity. According to the invention, EMNRPO electrons may result in strong enough electron-nucleus interaction for electrons to carry away some or all of the nuclear excitation energy. According to one aspect of the invention, excited electron states involving, for instance, EMNRPOs, may provide sufficient electron-nucleus interaction for electrons to carry away some or all of the nuclear excitation energy. Usually, excitation of electrons results in more delocalization, as electrons are pushed into higher energy orbitals. For the electron to be in an EMNRPO, the nature of excitation is found to be different from ordinary orbital excitations. According to the invention, electrons may be transitioned from “ordinary” atomic orbitals, such as s, p, d and f orbitals and hybridizations thereof, into EMNRPOs, such as zitterbewegung orbits. Said process to transition electrons from ordinary to EMNRPOs is here termed an “electron transition process” or “electron transition” and the accompanying transition is termed an “electron transition event”.

According to a preferred embodiment, it has been surprisingly discovered, that an exothermic reaction can be initiated in fuel. Moreover, the reaction has been surprisingly found to spontaneously initiate when the fuel is in a partially molten state, i.e. it contains both liquid (molten) and solid phases. It has been furthermore surprisingly discovered that such an exothermic reaction may be repeatedly re-initiated and/or sustained via a temperature cycling program, which has its lower temperature threshold in the vicinity where the fuel fully solidifies and has its upper temperature threshold in the vicinity where the fuel fully melts, here termed the phase change temperature range of the fuel. The periodicity of temperature cycling is preferably short enough for the exothermic reaction to be ongoing for a large fraction of time.

In one preferred embodiment ⁵⁸Ni is employed as all or part of the fuel. ⁵⁸Ni is the main isotope of nickel. It is a double electron capture capable nucleus. The consecutive capture of two electrons by the ⁵⁸Ni nucleus may result in an exothermic process. The stability of ⁵⁸Ni is believed to be due to the 400 keV energy required for a single electron capture, which produces ⁵⁸Co, which is an endothermic process (400 keV energy is needed to initiate the reaction). In an ordinary metallic environment, such as natural nickel, the ⁵⁸Co isotope may be transmuting, via electron capture, at 1.2% probability, and via positron emission at 98.8% probability [1].

In one preferred embodiment Ni and hydrogen and/or deuterium are employed as all or part of the fuel. In one preferred embodiment, the Ni of the fuel is an element of a molecule, alloy or salt of Ni which changes the orbital kinetic energy of one or more electrons compared to that of pure Ni.

According to one embodiment of the invention, an electron-mediated chain reaction process may occur. According to one embodiment, ⁵⁸Co decay may be accomplished mainly via an electron capture. According to one embodiment, both ⁵⁸Co and ⁵⁸Fe deexcitation may be shifted from the gamma photon emission path to mainly an electron emission and acceleration path. According to one embodiment, ⁵⁸Co decay may be shifted towards the electron capture pathway. According to one embodiment, ⁵⁸Co decay may be accomplished by shifting the ⁵⁸Fe deexcitation from gamma photon emission to electron acceleration. The net result of the above said electron assisted deexcitation processes is the multiplication of the number of energetic electrons within the electron-mediated chain reaction process cycles.

According to one embodiment of the invention, such a shift in the nuclear deexcitation pathway may require an environment with strong electron-nucleus interaction. It has been observed that a graphite environment can shift, to some extent, the deexcitation pathway of a fused ³He nucleus from gamma emission towards electron acceleration [2]. Specifically, all of the nuclear excitation energy of some nuclei may be carried away by energetic electrons.

In the first step of the sequence, the electron capture product may be ⁵⁸Co. The resulting ⁵⁸Co may be either in the ground state or in some excited state. The ⁵⁸Co may be in a low energy excitation state in comparison to the incoming electron energy. The isotope excitation may be long-lived. Here “Long lived” means that the excitation has a half-life of the same order of magnitude as the half-life of a close proximity electron-nucleus state. On the contrary, “Short lived” excitation has a half-life of at least one order of magnitude less than the half-life of close the proximity electron-nucleus state. On the same order of magnitude here means preferably less than 10 times and more than 0.1 times the half-life and more preferably less than five times and more than 0.2 times the half-life. Similarly, at least one order of magnitude less here means preferably less than 0.1 times the half-life.

TABLE I
Reaction sequence in ⁵⁸Ni according
to one embodiment of the invention

| Process step | I | II | III | IV |
|---|---|---|---|---|
| Signature | e⁻ | e⁻ | e⁻ | e⁻ |
| | capture | acceleration | capture | acceleration |
| Input e⁻ | >382 keV | e* | e* | e* |
| energy | | | | |
| Input nucleus | ⁵⁸Ni | ⁵⁸Co* + e* | ⁵⁸Co + e* | ⁵⁸Fe* + e* |
| Output nucleus | ⁵⁸Co* | ⁵⁸Co | ⁵⁸Fe* | ⁵⁸Fe |
| Output nucleus | up to 366 | 0 keV | mostly 811 | 0 keV |
| excitation | & 374 keV | | keV | |
| Output e⁻ | — | some >382 | — | mostly 811 |
| energy | | keV | | keV |

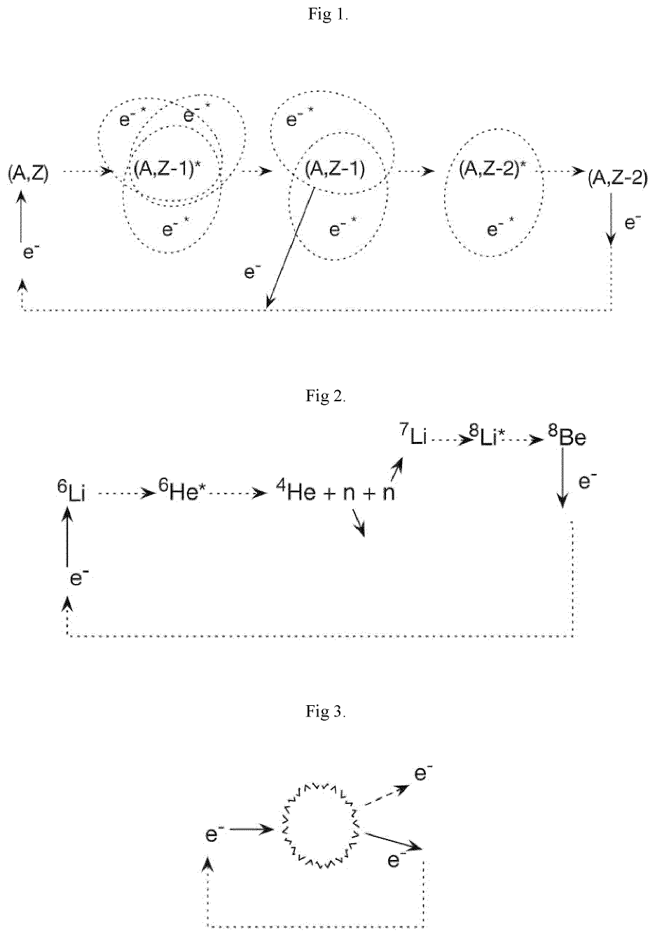

The overall reaction pathway of one embodiment of the invention is illustrated in Table I. The corresponding process flow is shown in FIG. 1. The process flow of an embodiment of electron-mediated nuclear chain reaction is shown in FIG. 3. According to this embodiment, the reaction sequence may be initiated in a fuel containing nuclide (A, Z) by an energetic electron. In the case of ⁵⁸Ni, the energetic electron may have at least 382 keV energy. For other fuels, the energetic electron has a different minimum energy. The chain reaction precondition may be that the output of the average reaction sequence generates an excess of such energetic electrons. In the case of ⁵⁸Ni containing fuel, the electron capture product may be ⁵⁸Co, which may be in the 25, 53, 112, 366, or 374 keV excited state; any of these states are possible from the energy balance of electrons produced in step IV. For other fuels, the electron capture produce may be another element and the excited state electron energy may be different. The chain reaction precondition may be that the output of the average reaction sequence generates >1 such energetic electrons.

In the current invention, we have identified a fuel structure, which shifts the subsequent reactions towards electron-nucleus interaction. Here fuel structure means the amount, state and composition of the fuel, which may include but is not limited to the mass of material, the physical arrangement (e.g. as a dense or disperse sphere, rod, cube, pile or geometric arrangement or e.g. as a powder or solid or void containing continuous structure), its material composition, its liquid, solid, gaseous or other state, its condition of charge or ionization, its isotope, its chemical bonds or chemical composition, etc. According to the invention, in such fuel structures, the electron-nucleus interaction may be stronger than the ordinary interaction between the innershell electrons and the nucleus. According to the invention, a suitable fuel structure for sufficiently strong electron-nucleus interaction may be characterized and/or assessed by the enhancement of nuclear fusion reaction probability in said fuel structure. An exemplary fuel structure has molten lithium, where the ²H-⁶Li fusion reaction probability enhancement has been characterized by 700 eV screening energy parameter [3], which is in strong contrast to the theoretically expected 50 eV screening energy parameter based on the Thomas-Fermi electron screening theory. An other exemplary fuel structure has graphite, where the ¹H-⁷Li fusion reaction probability enhancement has been characterized by a surprisingly high 10.3 keV screening energy parameter [4]. According to the invention, a suitable fuel structure for sufficiently strong electron-nucleus interaction may be furthermore characterized and assessed by the observation of electron-assisted nuclear de-excitation of some freshly fused nucleus, generating observable energetic electrons. An exemplary fuel structure has graphite, where energetic electrons have been observed in the output of ¹H-²H fusion reactions [2]. According to the invention, a suitable fuel structure for sufficiently strong electron-nucleus interaction may be furthermore characterized and assessed by the observation of such x-ray peaks originating from said fuel structure upon 1-20 keV particle bombardment, which are not originating from the electron orbitals of any chemical elements. An exemplary fuel structure has amorphous carbon (also known as diamond-like carbon), where x-rays peaks at different energy peaks from any orbital electron shell de-excitation process have been observed upon ion bombardment in 10-20 keV energy range [5]. Without intending to be bound by theory, the fusion probability enhancement and enhanced electron-nucleus interaction during nuclear reactions are understood to be a consequence of the presence of excited electrons in said environment. Such excited electrons may eventually de-excite by emitting x-rays. These may be at different energy peaks than any orbital electron shell de-excitation process. We propose that the nuclear magnetic field induced circulation of electron-hole pairs in graphite is within the radius of helium's s-electron orbital, thereby allowing electronic deexcitation of the graphite-embedded ³He.

According to one embodiment of the invention, a ⁵⁸Co-to-⁵⁸Fe transmutation pathway may be strongly shifted to the electron-nucleus interaction. An electron capture by a ⁵⁸Co nucleus may produce ⁵⁸Fe (e.g. at an approximately 811 keV excitation level). According to on embodiment of the invention, the ⁵⁸Co-to-⁵⁸Fe transmutation pathway may be strongly shifted to the electron-nucleus interaction. This may create condition allowing a self sustaining chain reaction.

It has been surprisingly discovered, that the sequence of electron mediated nuclear reaction processes may transition into a continuous or semi-continuous nuclear reaction process. According to one embodiment of the invention, such transition may occur during temperature cycling.

Regarding the question of initiating reactions, these can be started by rare electron capture events, which may occasionally take place in, for instance, ⁵⁸Ni. According to one embodiment of the invention, initiating reactions may be started by natural or spontaneous electron capture events. These events may take place in ⁵⁸Ni at a slow rate. These electron capture events may be naturally occurring and/or may be rare.

TABLE II
Reaction sequence in lithium according
to one embodiment of the invention

| Process step | I | II | III | IV |
|---|---|---|---|---|
| Signature | e⁻ capture | n emission | 2 captures of n | 2 emissions of |
| | | | | e⁻ |
| Input e⁻ | >5.3 MeV | — | — | — |
| energy | | | | |
| Input nucleus | ⁶Li | ⁶He | ⁷Li + n | ⁸Li |
| Output nucleus | ⁶He | ⁴He + 2n | ⁸Li | ⁸Be |
| Output nucleus | 1.8 MeV | 0 | 981 keV | 0 |
| excitation | | | | |
| Output e⁻ | — | — | — | 16 MeV |
| energy | | | | |

The overall reaction pathway of an other embodiment of the invention is illustrated in Table II. The corresponding process flow is shown in FIG. 2. The process flow of one example of electron-mediated nuclear chain reaction is shown in FIG. 3. According to this embodiment of the invention, electron-mediated chain reaction may be based on lithium. ⁶Li is capable of capturing an energetic electron with at least 3.5 MeV energy, and producing ⁶He. Upon the capture of such energetic electron, the ⁶He nucleus may be in an excited state of 1.8 MeV; this level is actually higher than the nucleus binding energy in ⁶He. However, a peculiar property of ⁶He is that it may emit two neutrons. Consequently, ⁶Li may be capable of capturing an energetic electron with at least 5.3 MeV energy, and then the resulting excited ⁶He may emit two neutrons. These emitted neutrons may in turn be captured by other lithium nuclei.

The neutron capture cross sections of ⁶Li and ⁷Li are of similar magnitude, and rather small. In order to enable the chain reaction, most neutrons must be captured by ⁷Li. Therefore the chain reaction capable fuel compositions may, according to one embodiment of the invention, consist of mainly ⁷Li, i.e. natural lithium may be suitable as well. Upon the capture of the two neutrons, close to two ⁸Li isotopes may be created from ⁷Li. The exact ⁸Li amount may depend on the ⁶Li: ⁷Li ratio, and may be >1 for the chain reaction to proceed. The ⁸Li isotope has a half-life of 0.84 s, and emits an energetic 16 MeV electron. These emitted electrons may then carry on the chain reaction.

Li may also react with electrons at a very high energy, starting from 11.2 MeV. However, ⁷Li has a much stronger magnetic dipole moment than ⁶Li, which is expected to significantly diminish its capability for energetic electron capture. With the exception of approaches close to the magnetic dipole axis, approaching energetic electrons may be deflected by a strong magnetic field around the nucleus. Therefore, considering the difference in the nuclear magnetic field strength and the difference in the required electron energy threshold, most energetic electrons are expected to be captured by ⁶Li, even when it has lower concentration in the mixture than ⁷Li.

Since lithium has a low neutron capture cross section, a limiting parameter may be the required lithium reservoir size for keeping most neutrons in; i.e. the reaction multiplication coefficient may be less than one for small lithium reservoirs. The reaction may be also self limiting by local evaporation of lithium.

According to one embodiment of the invention, the reaction rate may be enhanced by the use molten lithium. According to one embodiment, the existence of a molten/solid phase difference may increase the probability of neutron escape, i.e. that the produced neutrons escape more easily from the solid state than from the disordered liquid phase. In one embodiment of the invention, essentially all of the nuclear excitation energy of some or all nuclei has been carried away by energetic electrons. According to one embodiment of the invention, very close electron-nucleus proximity configurations, may result in strong enough electron-nucleus interaction for electrons to carry away the nuclear excitation energy.

We introduce the idea of excited electron states. In such states, electrons may be in very close proximity to the nucleus. Without intending to be bound by theory, these excited states might be either excitations of the electron's internal structure or electrons orbiting the nucleus at relativistic energy. These excited states, which may be excited electrons, may be characterized by, e.g., the following properties: (i) allow the presence of multiple close-proximity electrons around a nucleus, where the characteristic electron-nucleus distance may be within 10 pico-meters; (ii) excitation energy levels may be in the 1-10 keV energy range; (iii) excitation lifetimes may be in the 0.1-1 ms range; (iv) their production rate may be dependent on the chemical composition and structure of the reaction environment (the fuel structure).

Close electron-nucleus proximity electrons may be in a highly excited and/or highly localized state. The nature of excitation may be different from ordinary orbital excitations, which results in more delocalization, as electrons are pushed into higher energy orbitals. Herein, electrons in close electron-nucleus proximity to the nucleus (close electron-nucleus proximity electrons) may be electrons in highly localized states (highly localized electrons) and vice versa. Close electron-nucleus proximity electrons are said to be in a close electron-nucleus proximity electron state. Highly localized electrons are said to be in a highly localized electron state.

Not to be bound by theory, it is believed that, in general, a circulating electron orbital structure is toroidal in shape. Such toroidal current structure may be characterized by the electron's anapole moment (also referred to as toroidal moment) and charge radius parameters. The relativistic quantum mechanics based calculation of the electron's toroidal circulation radius and charge radius is generally referred to as the electron's “zitterbewegung”. The difference between the torus' inner and outer radius is twice the electron's charge radius, and the the electron current is circulating in both toroidal and poloidal directions, and the electron is locally moving at the speed of light. Here, we propose that our invention may be understood through a resonant electron-nucleus interaction mechanism; when the electron circulation frequency matches the condition for magnetic attraction, the electron starts orbiting the nucleus in a close proximity “zitterbewegung orbit”. Such resonant condition seems to be fulfilled when some electron state requires 85 eV for ionization.

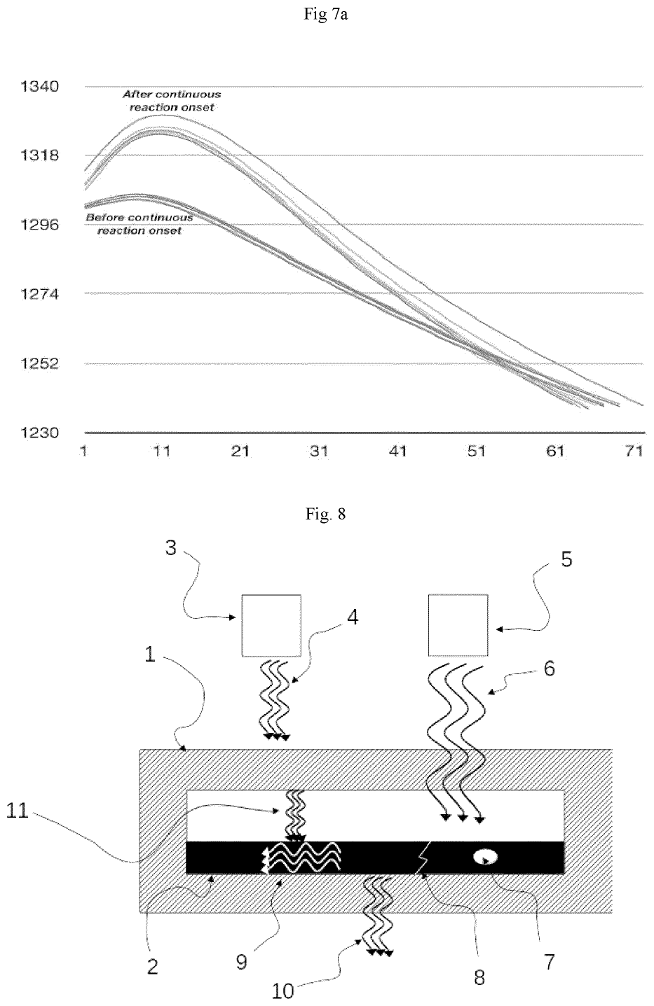

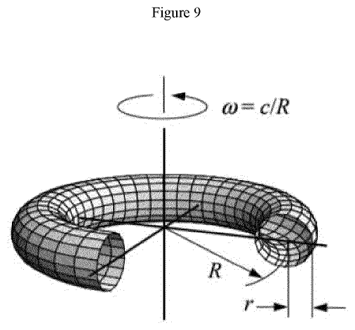

According to the invention, EMNRPOs can take a number of configurations. According to one embodiment of the invention, a close electron-nucleus proximity electron-nucleus configuration (close electron-nucleus proximity electrons) may be a highly localized electron configuration (highly localized electrons). One embodiment of a EMNRPO configuration which may be simultaneously in close electron-nucleus proximity, highly localized and metastable is the toroidal electron structure of an electron's zitterbewegung as sketched in FIG. 7. An electron in such a zitterbewegung orbit may be a close electron-nucleus proximity electron, metastable and/or a highly localized electron. This light-speed movement of electromagnetic fields around the circulation axes may be interpreted as the electron's wave-like aspect and can be described by the electromagnetic wave equation. The displacement of electromagnetic fields into the orthogonal direction to this toroidal plane may be interpreted as the electron's particle-like aspect and may be described by the equations of relativistic particle dynamic, i.e. the Dirac equation. The electromagnetic wave equation may describe electron oscillations within the toroidal zitterbewegung plane. The Dirac equation may describe the slower quantum mechanical oscillations in perpendicular direction to the zitterbewegung plane. These perpendicular quantum mechanical oscillations may be many orders of magnitude slower than the in-plane oscillations.

At the thermal energy scale, the presence of zitterbewegung orbits may be revealed by magnetic fields which cause a precession of its wave-like current loop circulation. As the electron energy level increases, it's dynamics may eventually be described relativistically, considering both particle-like mechanical motion and wave-like current loop motion

It is possible for an electron to have a stable state at a certain distance around a proton (¹H nucleus) at the reduced Compton wavelength scale. An example is the “zitterbewegung orbit”, and in this context the word “orbit” may refer to both particle-like and wavelike motions of the electron charge. When an electron ring is located around a proton at the reduced Compton wavelength radius of R₀≈0.38616 μm, its electrostatic potential is Uₚ₀≈−3.728 keV. Before falling into the proton's electrostatic potential well, the total electron energy may be denoted as Eₜₒₜₐₗ. The initial energy of the electromagnetic field, corresponding to the electron's wave-like motion, is Wₑₘ₀≈510.999 keV. At an orbital radius, R, around the proton, the potential energy is Uₚ=Uₚ₀ R/R₀ and the electromagnetic field energy of purely wave-like motion is Wₑₘ=Wₑₘ₀ R/R₀. For the magnetic field, this wave relation directly follows from W_{magnetic}=v2R. Since the magnetic and electric field energies of the electron's wave-like motion are equal, the same relation holds for the electric field energy. It is seen from this equation that large energy may be required to compress the electron into closer orbital than R₀. When the electron is in the state of purely wave-like circulation at an orbital radius R, the following energy balance equation holds:

WₑₘWₑₘ₀=Eₜₒₜₐₗ−U_{P} (1)

Based on the principle of particle-wave duality, in an equilibrium state, there may be an equivalence between a purely wave-like zitterbewegung motion and a simultaneous wave-like zitterbewegung plus relativistic particle-like motion. This equivalence means that in both cases the electron has the same orbital and its zitterbewegung stays centered around the nucleus. In the first case, the wave-like motion has an instantaneous speed vector cₑₘ, while in the later case there are two orthogonal instantaneous speed vectors: the wave-like v_{wave} and the particle-like v_{kinetic}, with c²=v²_{wave}+v²_{kinetic}. The two descriptions yield the same trajectory if c²=v²_{wave}+v²_{kinetic}. An other way to express this equivalence is to require that, upon reaching orbital radius R, the electron's particle-like rotation plus zitterbewegung rotation must be equal to a purely wave-like zitterbewegung rotation; i.e. the two orbitals may become indistinguishable. FIG. 12 illustrates the equivalence between these two descriptions of the electron. Since the electron is at a steady distance R from the proton (¹H nucleus), and moves at γ=1/(1−v²/c²)^{1/2}, the relativistic formulation of the virial theorem applies to its particle-like motion:

E_{kinetic}=−U_{P}γ/(γ+1) (2)

Formula (2) is derived from the relativistic expression of the virial term: =½βγm₀c·βc.

Considering that E_{kinetic}=(γ−1)m₀c², we get ½pv=(γ+1)/2γ E_{kinetic}, from which the above formula is derived. Formula (2) is valid for a motion along a straight line. The electromagnetic field energy of the complementing wave-like zitterbewegung current loop is:

W_{wave}=Wₑₘ/v_{wave}/c (3)

The total energy difference between a purely wave-like state and a wave-like plus relativistic particle-like state is:

ΔE=W_{wave}+E_{kinetic}−Wₑₘ (4)

Equation (2) cannot yet be exact, because it is applicable only to movements along straight line, while the particle-like electron motion is along a circular orbital. We therefore refine equation (2) by taking into account also the Thomas precession effect, which causes the circular orbital's angular speed to change as ω→γω in the frame of the electron. If the proton would be suddenly removed, the electron would continue its path along a straight line, without any instantaneous change of its momentum or kinetic energy with respect to the lab frame. However, its lab frame speed would instantaneously change because of the removal of Thomas precession. Let γ and β describe the electron's Lorentz factor and light speed fraction obtained according to equation (2). As discussed above, the Thomas precession effect does not change the electron's momentum or kinetic energy, therefore p=βγm₀c and E_{kinetic}=(γ−1)m₀c². However, since the electron precesses γ times faster in its own frame than in the lab frame, its lab frame speed becomes v=βc/γ. Using these formulas for p, v, and E_{kinetic}, the following refined kinetic energy formula is obtained from the relativistic formulation of the virial theorem:

E_{kinetic}=−Uₚγ²/(γ+1) (5)

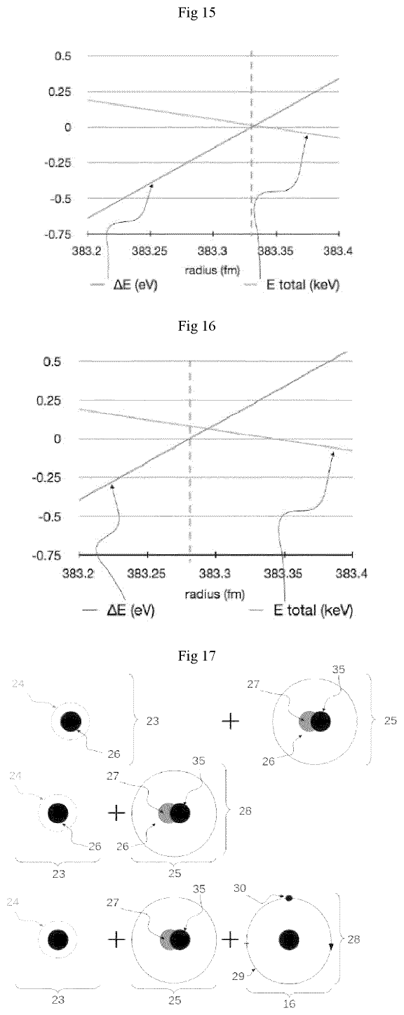

FIG. 15 shows Eₜₒₜₐₗ and ΔE as a function of R, calculated from the equations (3), (4), and (5). Based on the above stated wave-particle equivalence, we require ΔE=0. The meaning of an equilibrium state is that small perturbations around the equilibrium do not change the energy of the system, e.g. like gravitational energy equilibrium at the top of a hill or in the bottom of a valley. The electron's particle-like aspect is its movement in perpendicular direction to the zitterbewegung plane. The ΔE=0 condition means that small perturbations of the zitterbewegung orbit state may not change the energy of the system.

This ΔE=0 condition may be met at a negative binding energy, i.e. Eₜₒₜₐₗ>0. We note the interesting coincidence that the zitterbewegung radius has shrunk from its natural reduced Compton wavelength value by exactly one electron charge radius; i.e. by −2.82 fm. So far, we neglected in the analysis the magnetic electron-nucleus interactions. The following refined calculation considers the also Lorentz force experienced by the electron due to the proton's magnetic field.

To minimize the magnetic potential, the electron's and proton's magnetic moments may align their directions. Consequently, the proton's magnetic moment may be perpendicular to the zitterbewegung plane. The proton-originating magnetic field experienced by the electron may, therefore, also be perpendicular to the zitterbewegung plane, and may have the following magnitude: B=μ₀/4π×μ_{P}/R³≈2.5×10⁴ T. The above discussed electrostatic estimation of the equilibrium state gives β≈0.08558. The Lorentz force experienced by the electron is radial, and has a magnitude of F_{L}=ecβ3≈1.028×10⁻⁷ N. The radial Coulomb force experienced by the electron is F_{C}=−eU_{P}/R≈1.57×10⁻³N, which is four orders of magnitude larger than the magnetic force. Although the virial theorem is not applicable to a magnetic potential, since the magnetic force is so much smaller than the electrostatic force, and since the two forces are parallel, the magnetic effect can be treated as a linear perturbation of the electric potential. The effective force felt by the electron is F=F_{C}+F_{L}≈(1+6.55×10⁻⁵)×F_{C}. Equating the radial force with the radial derivative of potentials, we get F_{C}=−1/R U_{P} end F_{L}=−2/R U_{M}. Therefore, at a given radius, F_{L}/F_{C}=2UM/U_{P}. In other words, there needs to be twice as much Coulomb potential as magnetic potential in order to have the same force effect. Using linear perturbation, this additional force can be incorporated into the equation (5) by making U_{P}→˜(1+2×6.55×10⁻⁵)×U_{P} substitution. Considering that in the above estimation, U_{P}≈−3.756 keV, this additional force effect corresponds to ΔU_{P}≈0.49 eV.

FIG. 16 shows the Eₜₒₜₐₗ and ΔE values obtained after also taking into account the Lorentz force effect, calculated again from the equations (3), (4), and the U_{P}→U_{P}+˜0.49 eV adjusted equation (5). The ΔE=0 condition is met at Eₜₒₜₐₗ≈81 eV. This energy value is our final theoretical estimation for the required transition-initiating kinetic energy in case of a ¹H nucleus.

The obtained result shows that the required TIKE depends on the nuclear magnetic moment. It has been surprisingly found that, in the case of a ¹H nucleus, the ΔE=0 condition is met at Eₜₒₜₐₗ≈80-81 eV. This energy is found to be the required TIKE in case of a ¹H nucleus. The required TIKEEOMM may depend on the nuclear magnetic moment. The ²H nucleus' magnetic moment is −0.857 nuclear magnetons, which is significantly weaker than the ¹H nucleus' magnetic field. Using this magnetic moment value for the equilibrium state calculation, we obtain ΔU_{P}≈0.15 eV and Eₜₒₜₐₗ≈35 eV total energy for a zitterbewegung orbit around a ²H nucleus. This energy is found to be the required TIKE in case of a ²H nucleus.

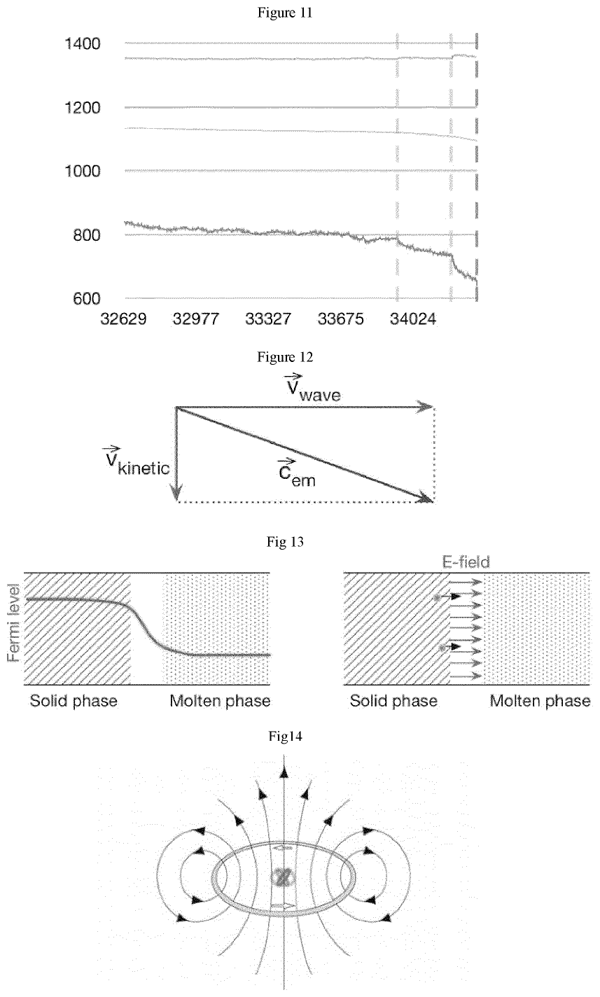

It has further been found that an electron's magnetic field may effect the proton (¹H nucleus) in the center. The strong induced magnetic field at the center of the electron orbital may interact with the proton's zitterbewegung motion, causing it to precess around the magnetic field lines. The induced precession of the proton's zitterbewegung motion may cause a Zeeman split in the proton's energy levels, and the proton may assume the lower energy level. This lowered proton energy level creates a restoring force for maintaining the equilibrium state; i.e. the electron's zitterbewegung orbit may then be in a magnetically stabilized metastable state. FIG. 13 illustrates the closely bound electron-proton (¹H nucleus) system in such a zitterbewegung orbit.

Thus, it has been surprisingly discovered that there is a metastable equilibrium electron orbital around a ¹H nucleus at the reduced Compton wavelength distance scale. This metastable orbital may be a close electron-nucleus proximity and/or highly localized electron orbital. This electron orbital may have a positive total energy. We emphasize that the positive total energy of this zitterbewegung orbit implies that, at ordinary temperatures, electrons occupy the lower energy Bohr orbital state around a ¹H nucleus, where Eₜₒₜₐₗ≈−13.6 eV.

Thus, we have surprisingly identified a particular example of an EMNRPO. This may be a zitterbewegung orbit. This orbital may exist around a ¹H nucleus or other light nucleus. Most preferably the light nucleus has atomic number Z=1, as in hydrogen (¹H) or deuterium (²H), though other light nuclei are possible according to the invention. An electron's EMNRPO, such as it zitterbewegung orbit, around a ¹H nucleus, or other light nucleus, may be understood as a fundamental relativistic state. At certain electron kinetic energy levels, the electron's zitterbewegung motion may localize itself as a relativistic orbital around a light nucleus. In the case of a ¹H nucleus, this kinetic energy is been found to be ˜80-˜81 eV for the TIKE, while for the ²H nucleus, this kinetic energy has been found to be ˜35 eV. This proposition allows us to correctly predict the reaction dynamics of, for instance, nickel-fueled or other material fueled reactors. Using relevant experimental data, in the following sections we will precisely identify this required TIKE.

Regarding nuclei with Z>1, we note that, for ⁴He, such state would not be stable because it has no nuclear magnetic moment. In case of lithium, it has been surprisingly found that the TIKE is ˜150 eV. However, the presence of a ZOE around a lithium nucleus would likely not meaningfully impact its fusion probability.

TABLE I
Comparison of the total electron energy level
in zitterbewegung orbit around various nuclei

| Nucleus | Potential Energy | Kinetic Energy | Total Electron Energy |
|---|---|---|---|
| ¹H | ~−3.756 keV | ~3.837 keV | ~80-81 eV |
| ²H | ~−3.756 keV | ~3.791 keV | ~35 eV |
| ⁷Li | ~−11.44 keV | ~11.59 keV | ~150 eV |

According to one embodiment of the invention, the electron kinetic energy may initiate a transition to an EMNRPO, such as a zitterbewegung orbit. According to one embodiment of the invention, the kinetically energetic electron does not need to be a free electron, but it may, instead, be an electron bound in an atomic orbital. Specifically, according to one embodiment of the invention, a bound electron of a TIKEEOM may transition into a EMNRPO, for instance, a zitterbewegung orbit, of a EMNRPOCM, such as a ZOOM. The EMNRPO, such as a zitterbewegung orbit, may be the EMNRPO, such as the zitterbewegung orbit, of, for instance, an ¹H or ²H nucleus. This may occur when the reactive nuclei material's wave function overlaps with an approaching EMNRPOCM having a EMNRPO electron. The reactive nuclei material may be any material having at least one neutron and may be, for instance, another EMNRPOCM, an NDECCI, a TIKEEOM and/or a TIKEEOMM, including, but not limited to, a TIKEEOCM or a TIKEEOMCM. The virial theorem states that, in a single electron hydrogen atom, the electron's kinetic energy is equal to its ionization energy. In multi-electron atoms this relationship may not be exact, but nevertheless we can use the electron ionization energy to estimate its kinetic energy. Nickel is an example of a TIKEEOM and/or TIKEEOMM for ¹H ZOOM according to the invention. Table II lists the estimated electron ionization energies for nickel's outer electrons. For the outermost N1 electron orbital, we used the available ionization energy data. For the other electrons, we accounted the relative x-ray transition energies between the N1 and other orbitals, and added the ionization energy of the N1 orbital.

TABLE II
Listing of electron ionization energies in nickel's outer orbitals

| orbital | N1 | M5 | M4 | M3 | M2 | M1 |
|---|---|---|---|---|---|---|
| Ionization energy (eV) | 7.64 | 15 | 15.7 | 79 | 84.2 | 124.4 |

An example of another TIKEEOMM or TIKEEOM for ¹H, is bromine. The ionization energy of bromine's electrons in the brominated organic compound can be estimated to be the similar as in the atomic bromine. Comparing data of Tables II and III, the common energy level appears to be at ˜79 to ˜80 eV.

TABLE III
Listing of electron ionization energies in bromine's outer orbitals

| orbital | N3 | N2 | N1 | M5 | M4 | M3 | M2 | M1 |
|---|---|---|---|---|---|---|---|---|
| Ionization | 12.5 | 11.8 | 23.5 | 78.3 | 79.4 | 191.2 | 198.5 | 264.8 |
| energy (eV) | | | | | | | | |

Using the same methodology, we calculate the electron kinetic energies of other elements around nickel. There are several elements which have close to ˜80-˜81 eV kinetic energy level and can act as a TIKEEOM and/or TIKEEOMM for a ¹H ZOCM. For instance, additionally, Cr, Cu, Co and V are also found to have suitable electron energy levels and can act as TIKEEOMMs and/or TIKEEOMs for ¹H ZOCMs. Other elements are possible, according to the invention, to have close to 80-81 eV kinetic energy level and can act as TIKEEOMMs and/or TIKEEOMs for ¹H ZOCMs.

As seen in Table IV, calcium contains 35 eV electron kinetic energy orbitals and can act as a TIKEEOM and/or TIKEEOMM for a ²H ZOCM. The M1 orbital's electron binding energy is 0.6 eV higher in CaO than in metallic Ca. Assuming similar energy shift also for the other M-orbitals, in CaO we estimate the M2 and M3 orbitals' kinetic energy levels at 35.6 and 35.1 eV, respectively. These energies are in good agreement with our theoretical prediction. Thus, CaO can act as a TIKEEOCM and/or TIKEEOM for a ²H ZOCM. Other elements are possible, according to the invention, to have close to 35 eV kinetic energy level and can act as TIKEEOMMs, TIKEEOCMs and/or TIKEEOMs for ²H ZOCMs.

TABLE IV
Listing of electron ionization energies in calcium's outer orbitals

| orbital | N1 | M3 | M2 | M1 |
|---|---|---|---|---|
| Ionization energy (eV) | 6.1 | 34.6 | 35 | 55.5 |

A transition into zitterbewegung orbit around a ¹H nucleus is found to occur at the ˜80-81 eV electron kinetic energy level, and at ˜35 eV in case of a ²H nucleus. Other materials with electron kinetic energies close to the total energy of zitterbewegung orbits around hydrogen and/or deuterium nuclei are possible according to the invention. Other materials with electron kinetic energies close to ˜80-˜81 and/or ˜35 eV, and can act as TIKEEOMs for, for instance, ¹H and ²H ZOCMs, are possible according to the invention.

It has been surprisingly discovered that electrons having TIKE may be those which are close to the required energy level, i.e. for a given TIKEEOMM, their kinetic energy may be close to the corresponding EMNRPOETE, for instance a ZOETE for a corresponding EMNRPOCM, such as a ZOOM. These may be, for instance, chemically inactive inner electrons. It has been further found that, when an electron's kinetic energy is close to the TIKE of a corresponding EMNRPOCM, such as a ZOOM, a small energy input, from, e.g., collisions between atoms, can energize such inner electrons having TIKEs to an electron transition energy level (i.e. a TIKEEO). Here small energy perturbations may be in the range of ˜1-10 eV. Said ˜1-10 eV collision energy may be higher than what can be normally supplied by thermal excitation. However, such collision energy may be supplied by, for instance, a Fermi level difference between interfaces, by an applied electric field, for instance, in an electrolysis setup, and/or by energetic plasmon oscillations. The Fermi level difference may be supplied by, for instance and melting phase change. Other sources or supplies of collision energy are possible according to the invention.

Certain surface layer materials in contact with the fuel may promote conditions for H⁺(¹H⁺) or D⁺(²H⁺) ions diffusing across an interface involving a Fermi level difference. The exothermic reaction power may be, therefore, proportional to the H⁺ or D⁺ diffusion rate, which is related to the temperature by the factor exp(−Eₐ/(k_{B}T)), where Eₐ is the activation energy for diffusion.

It has been surprisingly found that, when the fusion reaction involves a EMNRPOCM, such as a ZOCM, such as ¹H nuclei or ²H nuclei, any EMNRPO electrons around said nuclei may increase the probability of fusion between these screened ¹H nuclei or ²H nuclei and other nuclei, for instance, reactive nuclei. Therefore, measuring the fusion enhancement rate may also be a suitable proxy for measuring the production rate of such EMNRPO electrons, such as ZOEs. The production of EMNRPO electrons around a ¹H nucleus may happen via direct excitation of delocalized, free and/or unbound electrons. In the case of ¹H ZOEs, the direct excitement may be to ˜80-81 eV kinetic energy or via the small excitation of those bound electrons which have already close to ˜80-81 eV TIKE. In case of a ²H nucleus, this TIKE is close to 35 eV.

An example of an OMCM is PdO where oxygen's L1 orbital may be near ˜35 eV, at some locations. Here, oxygen may be a TIKEEOMM. Here Pd may be an OMM. Here, OMCM PdO may, thus, be, for instance, a TIKEEOCM and/or a TIKEEOM. Similarly, for zirconium and palladium, palladium-oxide and zirconium-oxide, an oxygen orbital kinetic energy may be near 35 eV at certain levels of oxidation. Here zirconium and palladium would be OMMs and palladium-oxide and zirconium-oxide would be OMCMs and, since these OMCMs would have one or more orbitals with kinetic energy near the ZOETE, they would also be, for instance, TIKEEOCMs and/or a TIKEEOMs. Oxygen may here be a TIKEEOMM. Oxidation states may be fully or partially oxidized. Certain relevant oxidation states may be uncommon oxidation states where, for instance, oxygen's L1 orbital energy may be close to a TIKE (˜35 eV for H and ˜80-˜81 eV for D). Such uncommon oxygen state may be present at the “nuclear active environment” sites. Similar states may exist for, e.g., carbonates, nitrates, sulfides, flourides, chlorides, bromides, iodides and/or hydrogenates. Other molecules may produce orbitals having TIKEEs.

EMNRPO electrons, e.g. ZOEs, may be produced by energetic particles, such as energetic electrons. The kinetic energy for such metastable state initiation may originate either from a delocalized electron energized to a TIKE or from a similar kinetic energy of a bound electron's orbital. Electrons with a TIKE may come from any source, including but not limited to free, unbound and/or delocalized electrons. Sources include but are not limited to, for instance, electron guns, electron beams or electron emitters, plasmas. Sources may provide one or more TIKEEs to one or more of their electrons. Other electron sources are possible according to the invention. Electrons having TIKE may be generated or otherwise provided by free or unbound atoms containing orbitals having such energies or atoms, when bound in molecules, containing orbitals and/or modified orbitals having such energies. Electrons having TIKE may be produced by reactions in the fuel.

The possibility of a positive feedback loop between the energetic electrons produced by a nuclear reaction and the production of more EMNRPOs during the braking of these energetic electrons may explain the pulsed reaction dynamics, which has been experimentally observed. Such a feedback loop may generate a chain reaction.

In one embodiment of the invention, thermally activated electron-mediated nuclear reactions can be initiated in the fuel, i.e., the electron-mediated nuclear reaction can be thermally activated. Thermally activated here means activated or initiated by a burst of thermal energy and/or radiation.

For the continuous reaction process, the disclosed process may involve the phase boundary between various materials and material mixture phases and utilize a Fermi level difference between these phases. Materials in the mixture may be charged in the metallic environment. During melting, the ions crossing over the molten-solid phase boundary may gain energy. Upon collision with ions in the molten phase, the produced braking radiation spectrum may extend above a critical threshold for some electrons of nearby material ions to transition into close proximity “zitterbewegung orbits”, with the braking radiation photons providing the missing energy. Continuous acceleration of ions during the heating phase may result in constant reaction power during the heating phase. There may be no similar ion accelerating process during the cooling phase.

Decelerating energetic ions or electrons may create excited electrons along their track, i.e. such >1 keV energy collisions with thermal electrons may produce excited electrons, which may become highly localized around some nuclei. Metal fracturing may produce energetic electrons, as reported in [6], or energetic neutrons, as reported in [7]. Both types of particle emissions may initiate the electron-mediated chain reaction, according to the invention. Reference [6] cites some observations of >100 keV energetic electron emissions from fractures; some fraction of these accelerated electrons may have the required >400 keV energy. The emission of neutrons from fracturing Fe-rich and Ni-rich metals has been reported in [7], employing multiple measurement techniques. Subsequently, the decay process of neutrons produces electrons with >400 keV energy. While a precise understanding of these energetic electron and neutron emissions' production during metallic fracturing requires further investigation, the observation of these phenomena is well established. Some theories about the physics of fractures are proposed in [6] and [8]. In any case, the chain reaction initiation may be caused by the occurrence of fractures. There may be strong mechanical stresses associated with nickel hydration process or with the lithiation of constantan under the condition of near melting point thermal gradients. These mechanical stresses are anticipated to produce a large number of fractures.

According to one embodiment of the invention, the chain reaction condition may require that electrons having sufficient energy, e.g., above 5.3 MeV, are captured by ⁶Li at high probability, before slowing down below this energy threshold. The electron capture cross section of ⁶Li may be between 5.3 to 16 MeV energy region. ⁷Li may also react with electrons at a very high energy, e.g., starting from 11.2 MeV. However, ⁷Li has a much stronger magnetic dipole moment than ⁶Li, which is expected to significantly diminish its capability for energetic electron capture. With the exception of approach angles close to the magnetic dipole axis, approaching energetic electrons may be deflected by a strong magnetic field around the nucleus. Therefore, considering the difference in the nuclear magnetic field strength and the difference in the required electron energy threshold, most energetic electrons are expected to be captured by ⁶Li, even when it has lower concentration in the mixture than ⁷Li.

Since lithium has a low neutron capture cross section, a limiting parameter may be the required lithium reservoir size for keeping most neutrons in; i.e. the reaction multiplication coefficient may be less than one for small lithium reservoirs. The reaction may be also self limiting by local evaporation of lithium.

The reservoir size is an example of an element of a fuel structure which promotes a multiplication factor greater than 1.

Upon more detailed investigation of the reaction mechanism, it has been discovered that the exothermic reaction may initially consists of a series of localized run-away exothermic reactions, forming a series of small ‘hot spots’. It has been discovered that the overall reaction may consist of two steps:

A triggering step which generates an initial exothermic reaction in one or more nuclei. Surprisingly, it was found that such triggering may be achieved for example by maintaining a temperature gradient close of the melting point of the employed alloy's solid phase, which results in a movement of crystal grain boundaries within the solid phase or in solid-to-liquid phase change. According to the invention, the chain reaction may also be initiated or triggered by any number of means. The means may either directly generate initiating double electron capture events, or produce high-energy electrons, ions of double electron capture capable isotope, or other materials in order to trigger the chain reaction upon impact.

A run-away chain reaction step, which rapidly terminates itself. This process takes place in the liquid (molten) phase, and is triggered by an initiating reaction. Such chain reaction is feasible when the alloy contains some alkali metal or alkali-earth metal constituent, preferably lithium. The use of any other alkali metal or alkali-earth metal constituent is possible according to the invention.

According to one embodiment of the invention, the sequence of electron mediated nuclear reaction processes may transition into a continuous or semi-continuous nuclear reaction process.

The general class of fuels capable of producing reactions according to one embodiment of the invention is summarized as follows:

The suitable fuel comprises at least in part of reactive nuclei for electron mediated nuclear chain reaction.

Other optional fuel constituents may be employed as modifying materials.

The general class of fuels capable of producing reactions according to another embodiment of the invention is summarized as follows:

One or more reactive nuclei materials for EMNR.

Another optional fuel element may be a EMNRPOCM.

Another optional fuel element may be a TIKEEOMM.

Another optional fuel element may be a OMM.

Another optional fuel element may be a modifying material.

Another optional fuel element may be an NDECCI.

The EMNRPOCM may be a ZOOM. Any one optional fuel element may serve multiple roles in the fuel including any combination of the above functions.

Any fuel or fuel composition conforming to the above listed parameters is possible according to this embodiment of the invention. Moreover, it is preferable that the fuel initiates an exothermic reaction in the partially molten fuel state. Though, in a preferred embodiment of the invention, the fuel or fuel elements may be lithium and/or nickel (Li, Ni), other fuels or fuel elements are possible according to the invention and, in combination, their ratios may vary according to the invention to achieve desired results.

According to the invention, heating of the fuel may be achieved by any means known in the art. The heating may be external (i.e. supplied to all or part of the fuel from outside the reaction process within and/or between the elements of the fuel), or internal or self-heating (i.e. supplied by the reaction process with and/or between the elements of fuel).

According to the invention, all or part of the heating may be supplied externally to the fuel by external heating. According to one preferred embodiment, the heating source may be a furnace heated resistively by the supply of an electric current. Other heating sources and means are possible according to the invention. Self-heating, cooling and/or external heating may be used, in combination, or separately, to control the temperature and/or temperature range of the fuel.

According to the invention, all or part of the heating may be supplied by self-heating (i.e. by all or part of the fuel itself). In a preferred embodiment of the invention, most of the heating—except for the initial starting heat—is supplied by self-heating. In a preferred embodiment of the invention, the self-heating is supplied by chemical and/or nuclear reaction. In such a case, the reaction may be initiated and/or maintained and/or controlled, at least in part, by self-heating. In such a case, the reaction may be terminated and/or maintained and/or controlled, at least in part, by cooling. In one embodiment, the heating component is in stand-by mode when the reactor temperature is above the desired minimum and is re-activated in case the reactor temperature drops below the desired minimum temperature threshold. The main challenge of self-heating based operation is to implement the above disclosed temperature cycling program. According to the invention, this temperature cycling may be achieved by a means of variable cooling rate. The cooling rate is increased near the upper temperature cycling threshold, and decreased near the lower temperature cycling threshold. Variable reactor cooling may be achieved by any means known in the art, such as controlled coolant flow or controlled thermal radiative power. In the latter case, the temperature may be controlled by balancing the radiated heat and the reflected and reabsorbed heat.

The reaction may be maintained and/or controlled by heating and/or cooling to within a target temperature range. The target temperature range may be bounded within 100° C. of each the fully solid and fully molten states of the employed fuel. The target temperature range may be within 50° C. of each the fully solid and/or fully molten states of the employed fuel. The target temperature range may be within 20° C. of each the fully solid and/or fully molten states of the employed fuel. The target temperature range may be within 10° C. of each the fully solid and/or fully molten states of the employed fuel. The target temperature range may be within 5° C. of each the fully solid and/or fully molten states of the employed fuel. Other target temperature ranges are possible according to the invention.

In one embodiment of the invention, the lower end of the target temperature range is maintained by external heating. In one embodiment of the invention, the upper end of the temperature range is maintained by external cooling. Such cooling may be by any means know in the art. In one embodiment of the invention, the cooling may be used to collect, store, transmit or convert energy.

In one embodiment of the invention, the cycling time between the maximum and minimum of the target temperature range is between 1 second and 7200 seconds. In one embodiment, the cycling time is between 8 seconds and 900 seconds. In an embodiment, the cycling time is between 20 seconds and 300 seconds. The cycling time is here defined as the time to return to the initial temperature boundary, be it high or low. Other cycling times are possible according to other embodiments of the invention.

According to the invention, the pressure at the fuel surface may be below 1000 atm. According to the invention, the pressure at the fuel surface may be below 100 atm. According to the invention, the pressure at the fuel surface may be below 10 atm.

In one embodiment of the invention, the fuel resides in a reactor vessel (a reactor). In one embodiment of the invention, the vessel is sealed and/or self-contained so that the contents of the vessel (e.g. fuel and residual or otherwise surrounding gases) are not in direct contact with the atmosphere outside the vessel or are otherwise maintained in an atmosphere essentially chemically inert to the metallic elements of the alloy. According to the invention, a vacuum is considered an inert atmosphere. In one embodiment of the invention, the vessel is sealed and/or self-contained. This sealing and/or containment may be by welding, capping, encasing and/or otherwise enclosing. Any means of sealing and/or enclosing the vessel is possible according to the invention. The sealing is aiming to preserve the integrity of the internal environment and not allow external materials to contact the contents of the vessel. The vessel may be comprised of a reaction (e.g. oxidation) resistant material and/or a pressure resistant material. In one embodiment of the invention, the oxidant resistant and pressure resistant materials are one in the same. In one embodiment of the invention, the fuel is first enclosed by a sealed pressure resistant vessel which is then enclosed by a sealed reaction resistant vessel. In this way, the combined vessel may be in contact with an oxidizing or otherwise reactive environment and/or the atmosphere surrounding the fuel may be essentially chemically inert to the metallic elements of the alloy.

Any reaction resistant solid material which can protect the contents of the vessel from the environment and/or maintain an essentially inert atmosphere around the fuel are possible according to the invention, including but not limited to various grades of iron, steel, molybdenum, titanium and/or carbon based materials such as graphite. According to one preferred embodiment of the invention, the reaction resistant vessel material is APM alloy. Any pressure resistant solid material which can protect the contents of the vessel from the environment and/or maintain an essentially inert atmosphere around the fuel are possible according to the invention, including but not limited to various grades of iron, steel, molybdenum, titanium and/or carbon based materials such as graphite. According to one preferred embodiment of the invention, the pressure resistant vessel material is TZM alloy.

In a preferred embodiment of the invention, some or all of the heat/energy of reaction is collected. This heat/energy may be collected, for instance, by a heat or energy sink. In one embodiment of the invention, the heat or energy sink is a coolant flow. In an other embodiment of the invention, the heat or energy sink is a thermally radiative surface.

In one embodiment of the invention, the properties of the heat or energy sink are varied to maintain all or part of the fuel within the target temperature range. According to the invention, the property of the heat or energy sink that is varied may be, for instance, the coolant heat conductivity, flow rate, flow pattern or direction, passage geometry, level of turbulence, pressure or pressure differential, temperature or temperature differential, viscosity, volume, mass, density, heat capacity, composition, structure, orientation, interface property, material radiative or reflective property or connectivity.

Some or all of the excess heat or energy of the reaction may leave the fuel and/or the reactor. This excess heat and/or energy may be, for instance, in the form of radiation, heated cooling medium or in any other form. Said excess heat and/or energy may be collected, for instance, in a heat or energy collecting medium such as a heat transfer fluid or a heat absorbing surface.

Collected heat or energy may be used to perform work, converted to another form of energy (e.g. electrical potential, potential, kinetic, phase change or chemical), stored in an energy storage system, or used for direct heating. Other forms of energy and energy storage systems are possible according to the invention.

Pressure, heat or energy produced by the described methods, apparatus and/or fuel of the invention may be used to perform work, converted to another form of energy (e.g. electrical, potential, kinetic, phase change or chemical bond structure), stored in an energy storage system, used for direct heating and/or power generation and/or converted to useful work, power and/or energy by any means known in the art. One common example is to transfer excess heat into a water cooling medium to produce steam and to pass said steam through as steam turbine to convert the energy into mechanical energy which then can be, for instance, converted into electrical energy. Other forms of energy generation, conversion and/or storage systems are possible according to the invention.

Since, according to one embodiment, the herein disclosed energy generating method requires only a metal or a combination of metals as input, does not generate harmful output waste, is easily controllable, and is nearly radioactivity free, it qualifies as an economical, clean and sustainable energy production technology.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Consequently, a skilled person may, on the basis of this disclosure and general knowledge, apply the provided teachings in order to implement the scope of the present invention as defined by the appended claims in each particular use case with necessary modifications, deletions, and additions. The fulcrum will substantially remain the same. Accordingly, it is not intended that the invention be limited, except as by the claims set forth below.

Moreover, any measured numerical values or values which are derived from measurements that appear in the description are approximate and their values may vary according to updated information as would be apparent to those of ordinary skill in the art. The symbols “˜” and “ ” indicate approximate values, preferably the value +/−32%, and more preferably the value +/−16%, and more preferably the value +/−8%, and more preferably the value +/−4%, and more preferably the value +/−2%, and most preferably the value +/−1%.

### EXAMPLES

In the following examples, a reactor, as described in FIG. 8, has been used according to the invention incorporating various fuels as described in the examples. In these examples, Ni may be an NDECCI, and its fusion with light nuclei is exothermic. Li is capable of energetic electron emission upon neutron capture, and its fusion with other nuclei is exothermic. Cu is a melting point modifying element, with possible beneficial role in catalyzing transition to close proximity electron-nucleus state.

In the following examples, any hydrogen present, in these cases, ¹H, may act as as an EMNRPOCM, in this case a ZOCM. In examples 2-6, Li may also act as a reactive nuclei material and Ni may also act as a TIKEEOM. Al and/or Cu may act as a modifying material and/or OMMs.

### Example 1

An experimental setup of one embodiment of the invention was used to generate energy from a single element fuel. In this example the single element fuel was used to generate an electron 0.5 g lithium was placed in a reactor and heated to 1370° C., in the presence of nickel material being in contact with the lithium fuel. The observed electron-mediated chain reaction bursts had varying strength and duration in our experiments, while the measured exothermic heat production has been several hundred Watts. During a strong burst, we detected radio-frequency signal generation with uniform power spreading in the 1-10 MHz frequency range; such flat radio-frequency power spectrum is an expected signature of decelerating energetic electrons. At the same time, a Geiger counter placed at 0.5 meter distance from the fuel container indicated a radiation level 40 times that of the background; this Geiger counter reading confirms the multiplication of energetic electrons by the herein disclosed electron mediated nuclear chain reaction.

The Geiger counter reading may indicate the multiplication of other energetic charged particles which may be, for example, electrons or ions. In our setup, hydrogen, which may serve as a zitterbewegung capable material, may be introduced in the form of LiOH, produced over lithium during the assembly and sealing of fuel containers in ambient air.

### Example 2

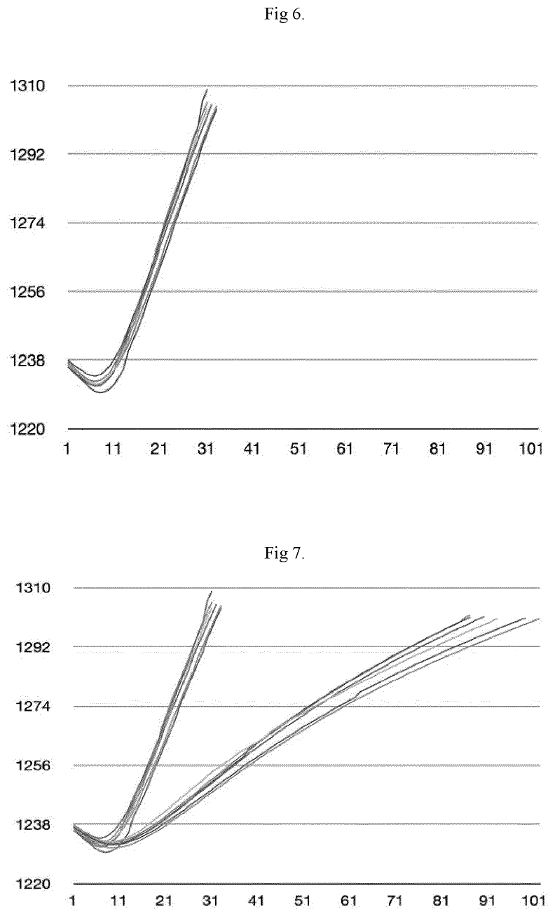

The employed fuel consists of 9.52 g constantan alloy and 0.28 g metallic lithium. The temperature program consisted of ramping up the reactor temperature to its operational range over 13 h, followed by the temperature cycling program: constant power heating was used from 1240 to 1300° C., the heating was turned off at the 1300° C. upper temperature threshold, and then the constant power heating was turned back on at the 1240° C. lower temperature threshold. FIG. 5 shows the temperature evolution overlay of a fuel sample during six consecutive heating phases of temperature cycling, prior to the onset of a continuous nuclear reaction. Signatures of electron-mediated nuclear chain reactions can be seen as sudden temperature jumps. The transition to a continuous reaction has occurred at the beginning of heating phase in a certain cycle. FIG. 6 shows the temperature evolution overlay of a fuel sample during six consecutive heating phases of temperature cycling, starting from the onset of a continuous nuclear reaction. The comparison of the temperature rise slopes before and after the onset of continuous nuclear reaction can be seen in FIG. 7. The continuous exothermic heat production can be seen from the constant slope of the temperature rise curves in FIG. 6. As shown in FIG. 6, some temperature jumps signatures of electron-mediated nuclear chain reactions can be found even after the onset of continuous nuclear reaction, in the first few post-onset cycles. It has been furthermore observed that the continuous exothermic heat production is significantly larger during the heating phases than during the cooling phases of temperature cycling. Therefore this nuclear reaction process may be semi-continuous.

FIGS. 7 and 7a show the temperature evolution of the heating and cooling phases in the 6 cycles before and after the continuous reaction start-up. The negative (vs. positive) numbers of labels indicate cycle numbers before (vs. after) the starting of continuous reaction.

The continuous reaction starts immediately after the start of a certain heating cycle (i.e. “cycle 1”), as can be seen from the steeper slope already at the beginning. The fairly constant slope during the heating cycles, as well as the very similar slope among the positive numbered cycles show that the reaction produces a constant exothermic power during the heating cycles. Signatures of the pulsed reaction (i.e. sudden temperature jumps) can be seen in some negative numbered preceding cycles, and also simultaneously to the continuous reaction in some positive numbered cycles. Cycles 1, 2, and 5 show very visible temperature jumps. In the cooling phase, the first observable feature is a temperature overshoot in the positive numbered cycles, relative to the temperature evolution of the negative numbered cycles. This indicates that the continuous reaction stays active for some seconds after the heating shut-off. Subsequently, the cooling rate is somewhat faster in the positive numbered cycles than in the negative numbered cycles. This is the consequence of local heat generation during the continuous reaction, which was picked up by the nearby thermocouple. It means that the average reactor temperature at the end of heating is somewhat lower in the positive numbered cycles than in the negative numbered cycles, because the electric heating was turned on for much shorter time. The dynamics of the temperature falling phase indicates little or no exothermic reaction during the temperature fall. Therefore, the reaction dynamics is actually semi-continuous, i.e. the continuous exothermic power is present mainly during the heating phases.

The longer term dynamics of this continuous reaction was analyzed by constructing the frequency spectrum of the temperature signal's autocorrelation function. FIG. 10 shows this spectrum for the initial part of the operating temperature regime, over the 20 minutes segment prior to the semi-continuous reaction onset, and then the spectrum for the duration of semi-continuous exothermic reaction. The top part of FIG. 10 has less sharp auto-correlation peaks, even though the transients at the start of operating temperature regime were excluded. This may be partly caused by remaining transients of the initial operating temperature regime and partly caused by the temperature bursts in the initial phase.

The continuous reaction part shows very sharp auto-correlation peaks and the absence of high-frequency noise. Since the heating program is controlled via temperature feedback, this data proves that the reaction dynamics is highly ordered, and remains nearly constant from cycle to cycle. There may be a reaction control parameter, which regulates the reaction rate to such constant value. Not to be bound by theory, the rate of nickel influx into the molten phase may be such control parameter. In summary, we have shown that the exothermic nuclear reaction of nickel-fueled reactors appears to be electron-mediated. In the initial phases it may be a pulsed process, and may subsequently transition into a continuous reaction process, which may be highly controllable. It is clearly seen from the data that the initial reaction bursts are a distinct process from the subsequent semi-continuous reaction process.

In our setup, hydrogen may be introduced in the form of LiOH, produced over lithium during the assembly and sealing of fuel containers in ambient air.

### Example 3

In one embodiment of the invention utilizing Ni, thermally activated electron-mediated nuclear reactions is initiated in the fuel, i.e., the electron-mediated nuclear reaction is thermally activated. For the main isotope of Ni, the possible exothermic nuclear reactions may either be double electron capture or fusion with an other nucleus. However, the electron energy difference from the 85 eV coupling energy level is high in ordinary Ni. Highly lithiated or hydrated phases of Ni are prepared, where the atomic fraction of lithium or hydrogen is above 10%; these phases have some electron energy levels closer to the equivalent of 85 eV ionization energy. Above 1000° C. operating temperature of the reactor, a thermal burst process may occur if the difference to the 85 eV level is within 1 eV. Such burst then amplifies locally with the increasing reaction temperature, as long as the required lithiated phase is available. In other words, the missing electron energy for the “zitterbewegung orbit” resonance level may be supplied by photons to the chemically inaccessible inner electrons. When some part of the fuel is heated to e.g. 0.1-0.2 eV energy level (1000-2000° C. temperature) during the burst reaction, a significant fraction of the thermal radiation spectrum may be above the missing energy difference, and the transition to the close proximity orbital may be induced by thermal radiation. As some enabled exothermic nuclear reaction locally heats up the fuel molecules, this process may propagate with the thermal radiation as a burst. The result is therefore a burst-like pulsed Ni reaction.

### Example 4

The employed fuel consists of 9.52 g constantan alloy and 0.28 g metallic lithium. The temperature program consisted of ramping up the reactor temperature to its operational range over 13 h, followed by the temperature cycling program: constant power heating was used from 1240 to 1300° C., the heating was turned off at the 1300° C. upper temperature threshold, and then the constant power heating was turned back on at the 1240° C. lower temperature threshold. During the temperature cycling it is found that the fuel retains a two phase composition, consisting of molten Li-rich and solid Cu and Ni rich phases. For the continuous reaction process, the disclosed process is found to involve the phase boundary between the molten Li-rich and the solid Cu and Ni rich phases of the employed fuel. The Fermi level difference between these two phases is 6-7 V. Since Cu and Ni are +2 charged in the metallic environment, during melting the ions crossing over the molten-solid phase boundary gain 12-14 eV on the average. Upon collision with ions in the molten phase, the produced braking radiation spectrum is understood to extend to at least 10 eV. Therefore, some electrons of nearby Ni, Cu, or Li ions are understood to transition into close proximity “zitterbewegung orbit”, with the absorbed braking radiation photons providing the missing energy enabling this transition. Without intending to be bound by theory, it is believed that upon this photon absorption some electrons have energy level equivalent to 85 eV ionization energy. Since the Constantan alloy has a continuous melting temperature range between 1250 and 1300° C., the continuous acceleration of ions during the heating phase from 1250 to 1300° C. is understood to explain the apparently constant reaction power during the heating phase. There is understood to be no similar ion accelerating process during the cooling phase. This difference is found to correspond to the observed approximately zero reaction power during the cooling phase from 1300 to 1250° C.

In our setup, hydrogen may be introduced in the form of LiOH, produced over lithium during the assembly and sealing of fuel containers in ambient air.

### Example 5

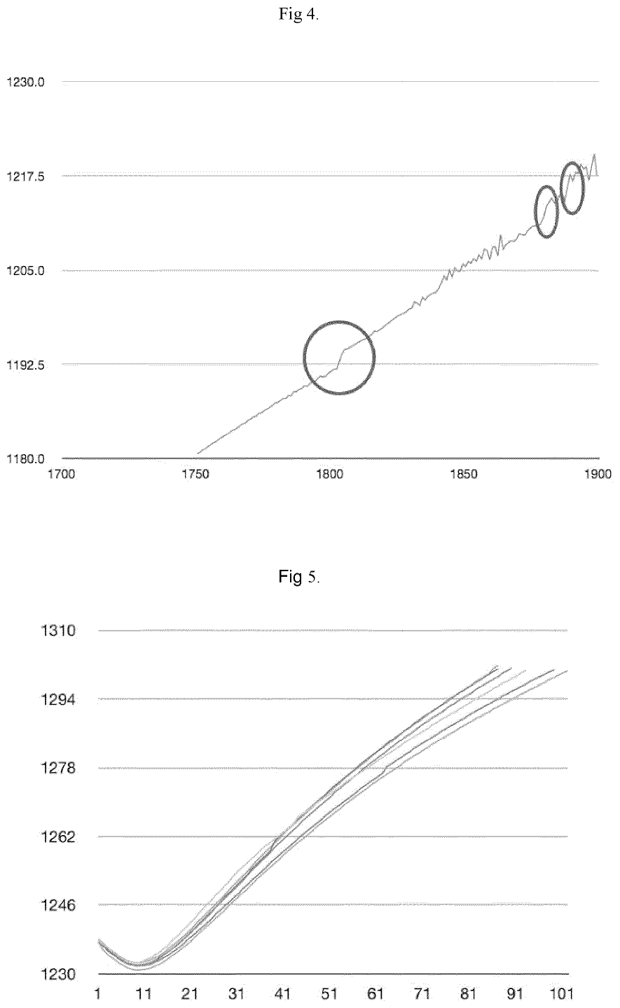

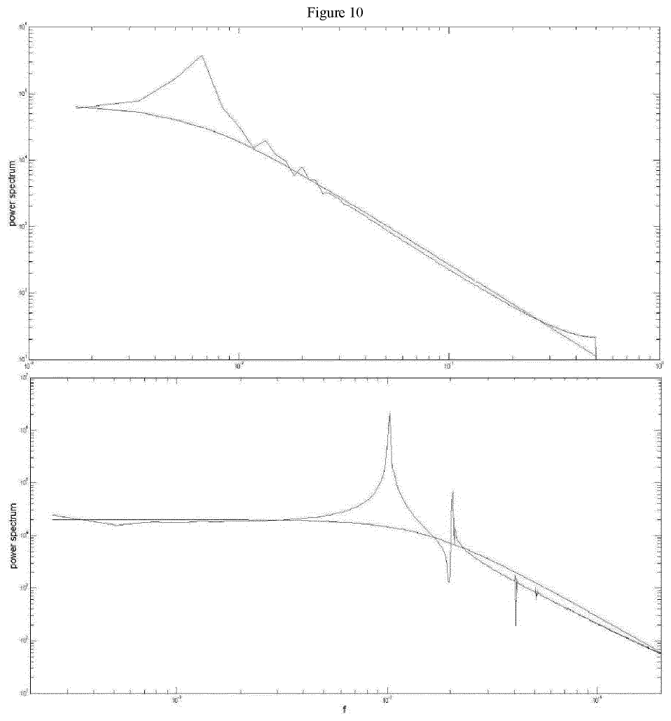

In the Li—Ni—Cu experiments, the reaction is observed starting from the 1200° C. limit (as shown in FIG. 4), which corresponds to the lowest melting temperature of the employed Constantan alloy. In this Li—Ni—Al experiment, the reaction is observed starting from the 1350° C. temperature limit (as shown in FIG. 11), This corresponds to the melting temperature of the AlNi3 phase, which is the lowest melting point phase within the nickel-rich nickel-aluminum alloys. The fuel above approximately 1200° C. is accompanied by electromagnetic noise while the temperature is rising. Many thermocouple-sensed electromagnetic disturbances were recorded, but are not attributable to the actual reaction signal, but instead, presumably, are signatures of such noise generating events. Decelerating energetic ions or electrons are understood to create excited electrons along their track, i.e. such >1 keV energy collisions with thermal electrons may produce excited electrons, which may become highly localized around some nuclei. Metal fracturing is understood to produce energetic electrons, or neutrons. Both types of particle emissions are understood to initiate the electron-mediated chain reaction. A chain reaction initiation is understood to be caused by the occurrence of fractures. FIG. 4 shows the distinction between non-exothermic fracture events, whose electro-magnetic signature appears as noise in the thermocouple reading, and actual exothermic reaction signatures which appear as temperature jumps. The non-exothermic nature of these precursor events can be seen from the constant slope of the temperature rise. These precursor events are produced during the heating of constantan alloy in the presence of molten lithium, when the temperature is raised above the 1200° C. threshold value.

In our setup, hydrogen may be introduced in the form of LiOH, produced over lithium during the assembly and sealing of fuel containers in ambient air.

### Example 6

We also investigated a lithium-nickel-aluminum fuel composition, enclosed in a welded stainless steel container. The approximate Li:Ni:Al atomic composition was 1:10:1. FIG. 11 shows the temperature evolution at the fuel container (top line) and at the edge of reactor (middle curve), as well as the heating power evolution (bottom curve). The horizontal axis shows the elapsed experiment time (seconds). After a slow temperature ramp-up, the left edge of the figure corresponds to the start of a constant 1350° C. temperature program. The thermocouple at the fuel container was used for the temperature feedback control. Initially, the heating power was gradually reduced as the reactor transitions from being heated up to maintaining the target temperature. The first vertical dashed line indicates the first reaction signature, which slightly raises the reactor temperature while the heating power is reduced. The next vertical dashed line indicates the second reaction signature, which further raises the reactor temperature while the heating power is reduced even faster. The falling heating power is corroborated by the falling temperature at the edge of the reactor. A run-away reaction has occurred shortly after the rightmost dashed line, which melted a large segment of the stainless steel container and destroyed the heating wires. This lithium-nickel-aluminum experiment indicates that the active fuel component in this example is nickel and/or lithium.

In the following examples, and on the basis of the above outlined electron transition process, we analyze collisions between atoms in those experimental setups where continuous energy production has been observed. The analysis of Ni—Li phase diagram reveals that Li alloys with Ni up to 10-15 atomic %, above which ratio there are two immiscible phases: a Ni-rich and a Li-rich phase. Similarly, the Cu—Li phase diagram indicates that Cu has a very low alloying capability with Li. Therefore, in our Li—Ni—Cu fueled experiments there may be a phase boundary between the molten Li rich and the solid Cu/Ni rich phases. The Fermi level difference between these two phases is estimated to be 5-7 V. FIG. 13 illustrates this electronic structure and the influx of cations into the accelerating boundary region during melting. Since Cu and Ni are +2 charged in the metallic environment, the ions crossing over the molten-solid phase boundary during melting process may gain 10-14 eV on average, accelerated by the electric field between these two phases. Their subsequent collision with ions in the molten phase may produce the conditions allowing the transition of some inner electron into close electron-nucleus proximity “zitterbewegung orbit”. In other words, some fraction of these accelerated ions' kinetic energy may provide the missing electron energy for electron transition to a highly localized and/or close electron-nucleus proximity orbital.

Not to be bound by theory, since the Constantin alloy has a continuous melting temperature range between 1250 and 1300° C., the continuous acceleration of ions during the heating phase may explain the apparently constant reaction power during the heating phase. No similar ion accelerating process has been found during the cooling phase. This difference corresponds to the observed, approximately zero, reaction power during the cooling phase.

### REFERENCES

[1] Live Chart of Nuclides, www-nds.iaea.org
[2] M. LipoglaySek et al “Observations of electron emission in the nuclear reaction between protons and deuterons”, Physics Letters B, Volume 773, 10 (2017), Pages 553-556
[3] J. Kasagi “Screening Potential for nuclear Reactions in Condensed Matter”, proceedings of the ICCF-14 International Conference on Condensed Matter Nuclear Science, Washington, D.C. (2008)
[4] M. Lipoglayšek “Catalysis of Nuclear Reactions by Electrons”, EPJ Web of Conferences, Volume 165 (2017)
[5] A. V. Bagulya et al “X-ray spectra from deuterated crystal structures interacting with ion beams with energies below 25 keV”, Journal of Surface Investigation: X-ray, Synchrotron and Neutron Techniques, Volume 11, 1 (2017), Pages 58-62
[6] G. Preparata “A New Look at Solid-State Fractures, Particle Emission and Cold Nuclear Fusion”, II Nuovo Cimento, Volume 104 A, 8 (1991)
[7] A. Carpinteri et al “Acoustic, Electromagnetic, Neutron Emissions from Fracture and Earthquakes”, Springer (2015)
[8] P. Hagelstein et al “Anomalies in Fracture Experiments, and Energy Exchange Between Vibrations and Nuclei”, Meccanica, Volume 50, 5 (2014), Pages 1189-1203.

The following is a table of abbreviations as used within this specification.

| ACRONYM | EXPANDED MEANING |
|---|---|
| EMNR | Electron-Mediated Nuclear Reaction |
| EMNCR | Electron-Mediated Nuclear Chain Reaction |
| EMNRPO | Electron Mediated Nuclear Reaction Promoting Orbital |
| EMNRPOCM | Electron Mediated Nuclear Reaction Promoting Orbital |
| | Capable Material |
| EMNRPOE | Electron Mediated Nuclear Reaction Promoting Orbital |
| | Electron |
| EMNRPOETE | Electron Mediated Nuclear Reaction Promoting Orbital |
| | Electron Total Energies |
| NDECCI | Nuclear Double Electron Capture Capable Isotope |
| OMCM | Orbital Modified Compound Material |
| OMM | Orbit Modifying Material |
| TIKE | Transition-Initiating Kinetic Energies |
| TIKEE | Transition-Initiating Kinetic Energy Electron |
| TIKEEO | Transition-Initiating Kinetic Energy Electron Orbital |
| TIKEEOM | Transition-Initiating Kinetic Energy Electron Orbital |
| | Material |
| TIKEEOCM | Transition-Initiating Kinetic Energy Electron Orbital |
| | Compound Material |
| TIKEEOMM | Transition-Initiating Kinetic Energy Electron Orbital |
| | Modulatable Material |
| TIKEEOMCM | Transition-Initiating Kinetic Energy Electron Orbital |
| | Modulatable Compound Material |
| ZOCM | Zitterbewegung Orbit Capable Material |
| ZOE | Zitterbewegung Orbital Electron |
| ZOETE | Zitterbewegung Orbital Electron Total Energie |

Since the inventions described in detail above are exemplary embodiments, they can be modified to a large extent in the usual way by a person skilled in the art without leaving the field of the invention. In particular, the arrangements and the proportions of the individual elements to each other are simply exemplary. Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

1. A fuel for nuclear reaction comprising:
one or more Electron Mediated Nuclear Reaction Promoting Orbital Capable Materials, wherein the one or more Electron Mediated Nuclear Reaction Promoting Orbital Capable Materials are materials capable of at least one of forming and maintaining, for a period of time, one or more Electron Mediated Nuclear Reaction Promoting Orbitals, wherein the one or more Electron Mediated Nuclear Reaction Promoting Orbitals have a have an average electron orbital distance from a nucleus of less than 10 pico-meters; and
one or more reactive nuclei materials, wherein said reactive nuclei materials comprise a nucleus having at least of one neutron and one proton.

2. The fuel according to claim 3, further comprising:
one or more Transition-Initiating Kinetic Energy Electron Orbital Materials comprising at least one Transition-Initiating Kinetic Energy Electron Orbital having at least one Transition-Initiating Kinetic Energy Electron having a Transition-Initiating Kinetic Energy within +/−10 eV of the Electron Mediated Nuclear Reaction Promoting Orbital Electron Total Energy of one or more Electron Mediated Nuclear Reaction Promoting Orbital Electrons of one or more Electron Mediated Nuclear Reaction Promoting Orbitals of one or more of the Electron Mediated Nuclear Reaction Promoting Orbital Capable Materials;
one or more modifying material; and/or
wherein, at least one of:
one or more of the reactive nuclei materials is a Nuclear Double Electron Capture Capable Isotope;
at least one of the reactive nuclei materials is at least one of ¹H, ²H, ³H, He, Ne, Li Be, B, C, N, O, F and Na;
one or more of the Electron Mediated Nuclear Reaction Promoting Orbital Capable Materials is a Zitterbewegung Orbit Capable Material;
one at least one of the Electron Mediated Nuclear Reaction Promoting Orbital Capable Materials and reactive nuclei materials comprise a light nucleus material having an atomic number of less than or equal to 11; and
one or more of the reactive nuclei materials comprises a metal.

3. The fuel according to claim 2, wherein at least one of:
one or more of the Transition-Initiating Kinetic Energy Electron Orbital Materials is a Transition-Initiating Kinetic Energy Electron Orbital Compound Material comprising at least one of Transition-initiating Kinetic Energy Electron Orbital Materials, one or more Transition-Initiating Kinetic Energy Electron Orbital Modulatable Materials, and one or more Transition-Initiating Kinetic Energy Electron Orbital Modulatable Compound Materials;
one or more modifying material comprises at least one Cu and Al;
one or more modifying material comprises at least one of an Orbit Modifying Material, a melting point modifying material, a fracture-inducing material, a material capable of sustaining excited electrons, a material having different Fermi levels in the molten and solid phases and a saturating material;
one or more of the Transition-Initiating Kinetic Energy Electron Orbital Materials comprises a metal;
at least one of the Nuclear Double Electron Capture Capable Isotope comprises at least one of ⁶Li, ⁷Li, ⁵⁸Ni, ⁶⁴Zn, and ⁴⁰Ca;
one or more of the Zitterbewegung Orbit Capable Material comprise at least one of ¹H, ²H and ³H;
one or more Transition-Initiating Kinetic Energy Electron Orbital Materials are part of, chemically bonded to, alloyed with, or are otherwise in contact with, an OMM so as to form a Transition-Initiating Kinetic Energy Electron Orbital Compound Material;
one or more of the Transition-Initiating Kinetic Energy Electron Orbital Materials comprise at least one Transition-Initiating Kinetic Energy Electron in a Transition-Initiating Kinetic Energy Electron Orbital with a Transition-Initiating Kinetic Energy having a kinetic energy within +/−10 eV of the Zitterbewegung Orbit Electron Total Energy of one or more of the Zitterbewegung Orbit Capable Material;
one or more of the Transition-Initiating Kinetic Energy Electron Orbital Materials comprise at least one of Ni, Br, Co, Ca, O, Cu, Cr and V; and
one or more of the Zitterbewegung Orbit Capable Material comprise at least one of 1H having a Zitterbewegung Orbit Electron Total Energy of 80-81 eV and ²H having a Zitterbewegung Orbit Electron Total Energy of 35 eV.

4.-19. (canceled)

20. A method for producing an Electron Mediated Nuclear Reaction comprising the steps of:
introducing one or more magnetic fields of greater than 1 MTesla;
exothermically rearranging, by means of one or more of the magnetic fields, one or more nuclear bonds within the fuel;
exothermically breaking up, by means of one or more of the magnetic fields, one or more nuclear bonds within the fuel;
exothermically breaking up, by means of one or more of the magnetic fields, one or more nucleons within the fuel; and
supplying a fuel comprising:
one or more Electron Mediated Nuclear Reaction Promoting Orbital Capable Materials, wherein the one or more Electron Mediated Nuclear Reaction Promoting Orbital Capable Materials are materials capable of at least one of forming and maintaining, for a period of time, one or more Electron Mediated Nuclear Reaction Promoting Orbitals, wherein the one or more Electron Mediated Nuclear Reaction Promoting Orbitals have a have an average electron orbital distance from a nucleus of less than 10 pico-meters;
one or more reactive nuclei materials, wherein said reactive nuclei materials comprise a nucleus having at least of one neutron and one proton; and
supplying one or more Transition-Initiating Kinetic Energy Electrons to a reactor, wherein one or more of the Transition-Initiating Kinetic Energy Electrons are bound in a Transition-Initiating Kinetic Energy Electron Orbital of at least one of a Transition-initiating Kinetic Energy Electron Orbital Material and one or more of the Transition-Initiating Kinetic Energy Electrons are unbound.

21.-37. (canceled)

38. The fuel according to claim 3, wherein at least one of:
at least one of the Transition-Initiating Kinetic Energy Electron Orbital Modulatable Material, Transition-Initiating Kinetic Energy Electron Orbital Compound Material and Transition-Initiating Kinetic Energy Electron Orbital Modulatable Compound Material comprises a metal;
at least one of the light nucleus Electron Mediated Nuclear Reaction Promoting Orbital Capable Material comprises a material having an atomic number, Z, equal to 1;
at least one of the Transition-Initiating Kinetic Energy Electron Orbital Modulatable Material, Transition-Initiating Kinetic Energy Electron Orbital Compound Material and Transition-Initiating Kinetic Energy Electron Orbital Modulatable Compound Material are part of, chemically bonded to, alloyed with, or are otherwise in contact with, an OMM so as to form a Transition-Initiating Kinetic Energy Electron Orbital Compound Material; and
one or more Transition-Initiating Kinetic Energy Electron Orbital Compound Material are at least one of molecules, alloys or salts comprising at least one of Transition-Initiating Kinetic Energy Electron Orbital Modulatable Material and Transition-Initiating Kinetic Energy Electron Orbital Modulatable Compound Material, and at least one Orbit Modifying Material; and a surface or coating of Orbit Modifying Material in contact with at least one Transition-Initiating Kinetic Energy Electron Orbital Modulatable Material and Transition-Initiating Kinetic Energy Electron Orbital Modulatable Compound Material.

39. The fuel according to claim 38, wherein one or more of the materials having an atomic number, Z, equal to 1 comprise at least one of ¹H, ²H ³H.

40. The method according to claim 20, wherein
one or more of the magnetic fields are created by at least one of:
one or more bound electrons;
one or more Transition-Initiating Kinetic Energy Electrons;
one or more bound electrons, wherein one or more of the bound electrons is a Transition-Initiating Kinetic Energy Electron; and
one or more Electron Mediated Nuclear Reaction Promoting Orbital Electrons in one or more Electron Mediated Nuclear Reaction Promoting Orbitals of one or more Electron Mediated Nuclear Reaction Promoting Orbital Capable Materials; and
one or more of the Transition-Initiating Kinetic Energy Electrons are transitioned to one or more of the Electron Mediated Nuclear Reaction Promoting Orbitals of one or more Electron Mediated Nuclear Reaction Promoting Orbital Capable Materials, thereby becoming one or more Electron Mediated Nuclear Reaction Promoting Orbital Electrons, which then catalyze, enhance or otherwise promote one or more Electron Mediated Nuclear Reactions in one or more reactive nuclei of one or more reactive nuclei materials.

41. The method according to claim 20, wherein one or more of the bound Transition-Initiating Kinetic Energy Electrons transition to an Electron Mediated Nuclear Reaction Promoting Orbital of one or more of the Electron Mediated Nuclear Reaction Promoting Orbital Capable Material by at least one of:
diffusing one or more Electron Mediated Nuclear Reaction Promoting Orbital Capable Material through a material comprising Transition-Initiating Kinetic Energy Electron Orbital Material;
accelerating one or more Electron Mediated Nuclear Reaction Promoting Orbital Capable Materials into a material comprising Transition-Initiating Kinetic Energy Electron Orbital Material; and
accelerating one or more Transition-Initiating Kinetic Energy Electron Orbital Materials into a material comprising Electron Mediated Nuclear Reaction Promoting Orbital Capable Material.

42. The method according to claim 20, wherein:
the gain in kinetic energy of at least one of the Electron Mediated Nuclear Reaction Promoting Orbital Capable Material the Transition-Initiating Kinetic Energy Electron Orbital Material after acceleration is less than 10 eV, and
at least one of the Electron Mediated Nuclear Reaction Promoting Orbital Capable Material and Transition-Initiating Kinetic Energy Electron Orbital Material are accelerated by surface plasmons, surface voltage during electrolysis, fracturing or by a Fermi-level difference.

43. The method according to claim 20, wherein:
one or more electrons are transitioned to Electron Mediated Nuclear Reaction Promoting Orbital by one or more unbound Transition-Initiating Kinetic Energy Electron supplied by at least one of:
i) providing a plasma comprising one or more Electron Mediated Nuclear Reaction Promoting Orbital Capable Material, wherein the plasma temperature is within +/−10 eV of one or more of the Electron Mediated Nuclear Reaction Promoting Orbital Electron Total Energies of one or more of the Electron Mediated Nuclear Reaction Promoting Orbital in the fuel; and
ii) bombarding a fuel comprising Electron Mediated Nuclear Reaction Promoting Orbital Capable Material with electrons with kinetic energies within +/−10 eV one or more of the Electron Mediated Nuclear Reaction Promoting Orbital Electron Total Energies of one or more of the Electron Mediated Nuclear Reaction Promoting Orbital in the fuel; and
one or more electrons are transitioned to Electron Mediated Nuclear Reaction Promoting Orbital by bombarding a fuel comprising Electron Mediated Nuclear Reaction Promoting Orbital Capable Material with ions with kinetic energies within +/−10 eV of three times (3×) the Electron Mediated Nuclear Reaction Promoting Orbital Electron Total Energies of one or more of the Electron Mediated Nuclear Reaction Promoting Orbitals in the fuel.

44. The method according to claim 20, wherein at least one of
one or more bound electrons are supplied by at least one of
i) transitioning one or more Transition-Initiating Kinetic Energy Electron with kinetic energies within 10 eV of 80-81 eV to an Electron Mediated Nuclear Reaction Promoting Orbital of one or more Electron Mediated Nuclear Reaction Promoting Zitterbewegung Orbit Capable Material comprising ¹H; and
ii) transitioning one or more Transition-Initiating Kinetic Energy Electrons with kinetic energies within +/−10 eV of 35 eV to an Electron Mediated Nuclear Reaction Promoting Orbital of one or more Electron Mediated Nuclear Reaction Promoting Zitterbewegung Orbit Capable Material comprising ²H; and
at least one of the Electron Mediated Nuclear Reaction Promoting Orbital Capable Material is a Zitterbewegung Orbit Capable Material and at least one of the Electron Mediated Nuclear Reaction Promoting Orbitals is a zitterbewegung orbit; and
the ions with kinetic energies with kinetic energies within +/−10 eV of three times (3×) the Electron Mediated Nuclear Reaction Promoting Orbital Electron Total Energies of at least one of the Electron Mediated Nuclear Reaction Promoting Orbitals in the fuel are Electron Mediated Nuclear Reaction Promoting Orbital Capable Material ions.

45. The method according to claim 42, wherein at least one of
a Fermi-level difference is generated by at least one of a melting phase change and a fracture;
at least one of a melting phase change and a fracture are generated by temperature cycling within a target temperature range, wherein the target temperature range is bounded within 100° C. of each of the fully solid and fully molten states of all or part of the fuel; and
a Fermi-level difference is generated by at least one of a melting phase change and a fracture, which is generated by temperature cycling within a target temperature range, wherein the target temperature range is bounded within 100° C. of each of the fully solid and fully molten states of all or part of the fuel.

46. An apparatus for at least one of heat and energy production, comprising:
a reactor containing a fuel one or more Electron Mediated Nuclear Reaction Promoting Orbital Capable Materials, wherein the one or more Electron Mediated Nuclear Reaction Promoting Orbital Capable Materials are materials capable of at least one of forming and maintaining, for a period of time, one or more Electron Mediated Nuclear Reaction Promoting Orbitals, wherein the one or more Electron Mediated Nuclear Reaction Promoting Orbitals have a have an average electron orbital distance from a nucleus of less than 10 pico-meters;
one or more reactive nuclei materials, wherein said reactive nuclei materials comprise a nucleus having at least of one neutron and one proton;
means for supplying energetic particles onto the fuel to at least one of initiate and maintain one or more Electron-Mediated Nuclear Reaction a in the fuel, wherein at least one of the energetic particles are at least one of energetic protons, neutrons, unbound electrons, ions, Transition-Initiating Kinetic Energy Electron Orbital Material a, reactive nuclei materials and Electron Mediated Nuclear Reaction Promoting Orbital Capable Materials; and
means for at least one of collecting and converting the at least one of heat and energy produced by the EMNR.

47. The apparatus of claim 46, further comprising at least one of:
means for generating a chain reaction, wherein the fuel has a fuel structure with a multiplication factor of energetic electrons larger than one and wherein the fuel structure is defined by the fuel's amount, density, state, composition, arrangement, condition of charge, isotope and/or chemical bond structure;
wherein the means of supplying energetic particles is at least one of:
a particle accelerator and
a furnace for cycling all or part of the fuel within a target temperature range, wherein the furnace comprises one or more temperature or radiation sensors, one or more power supplies for supplying power or energy to the reactor and/or fuel and a controller for varying the power or energy to the reactor and/or fuel and/or for varying the rate or amount of heat, radiation and/or energy released from and/or reflected back to the reactor and/or fuel, so as to keep all or part of the fuel within a target temperature range, wherein the target temperature range is bounded within 100° C. of each the fully solid and fully molten states of all or part of the fuel;
wherein one or more of the energetic particles are electrons and/or one or more of the energetic particles produce energetic electrons; and
wherein at least one of the energetic particles are bound electrons in one or more Electron Mediated Nuclear Reaction Promoting Orbitals of one or more Electron Mediated Nuclear Reaction Promoting Orbital Capable Materials.
